(19) United States
(12) Patent Application Publication
(10) Pub. No.: US 2026/0017965 A1
(43) Pub. Date: Jan. 15, 2026

(54) GENERATING BOUNDING BOXES FOR INFORMATION EXTRACTED FROM DOCUMENTS WITH LARGE LANGUAGE MODELS

(71) Applicant: Intuit Inc., Mountain View, CA (US)

(72) Inventors: Peter Caton ANTHONY, Menlo Park, CA (US); Manish BHATIA, Las Vegas, NV (US); Hui CHEN, San Jose, CA (US); Jadiel DE ARMAS, Clermont, FL (US); Guohan GAO, San Jose, CA (US); Nandish JAYARAM, Dublin, CA (US); Tharathorn RIMCHALA, San Francisco, CA (US)

(21) Appl. No.: 18/767,081

(22) Filed: Jul. 9, 2024

(51) Int. Cl. G06V 30/14; G06V 30/19; G06V 30/412; G06V 30/414

(52) U.S. Cl. CPC G06V 30/1448; G06V 30/19093; G06V 30/412; G06V 30/414

(57) ABSTRACT

Certain aspects of the disclosure provide techniques for bounding box annotation for automated information extraction. A method generally includes obtaining an extracted field value for a field key of a document using optical character recognition (OCR) data generated based on the document, wherein: the OCR data comprises OCR tokens and bounding boxes, each associated with one OCR token; generating a value union bounding box surrounding value bounding box(es) of the bounding boxes, wherein: the value bounding box(es) satisfy a first threshold; and the value bounding box(es) are associated with first OCR token(s) of the plurality of OCR tokens that satisfy a second threshold when compared to one or more field value tokens of the extracted field value; and generating an output bounding box for display on a computing device with the document based on relative coordinates of the value union bounding box with respect to known dimensions of the document.

### BACKGROUND

### Field

Aspects of the present disclosure relate to bounding box generation for automated information extraction.

### Description of Related Art

Automated information extraction is the process of extracting information from electronic data without manual intervention. For example, automated information extraction may involve using automated methods and/or tools to scan and extract information from various sources, and, in some cases, convert the extracted information into a usable and meaningful format for further analysis, reporting, and/or storage. The various sources from which information is extracted may include text, documents, images, forms, tables, spreadsheets, receipts, invoices, and others. The extracted information may be used in various applications and/or analytics downstream in many different industries, including engineering, healthcare, education, government, mathematics, human resources, and finance, to name a few.

For example, in the field of human resources and recruitment, automated information extraction may be used to extract relevant information from job applicants' resumes or CVs. The extracted information may be stored and analyzed by an applicant tracking system used to track candidates throughout recruiting and/or hiring processes. As another example, in the finance industry, automated information extraction may be used to extract relevant information from tax forms, invoices, and/or receipts (e.g., in some cases provided as images by a taxpayer) to perform tax calculations and/or prepare a taxpayer's tax return, among other tasks.

### SUMMARY

One aspect provides a method of generating one or more bounding boxes for computer-extracted information. The method generally includes obtaining an extracted field value for a field key of a document using optical character recognition (OCR) data generated based on the document, wherein: the OCR data comprises a plurality of OCR tokens, the OCR data comprises a plurality of bounding boxes, each associated with one OCR token of the plurality of OCR tokens, and the extracted field value comprises one or more field value tokens; generating a value union bounding box surrounding one or more value bounding boxes of the plurality of bounding boxes, wherein: the one or more value bounding boxes satisfy a first threshold; and the one or more value bounding boxes are associated with one or more first OCR tokens of the plurality of OCR tokens that satisfy a second threshold when compared to the one or more field value tokens; and generating an output bounding box for display on a computing device with the document based on first relative coordinates of the value union bounding box with respect to known dimensions of the document.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system implementing an extractor and a bounding box generator.

FIG. 2A depicts an example workflow used to extract information for field key(s) in a document and generate bounding boxes for information extracted from the document.

FIG. 2B depicts an example trie data structure.

FIG. 2C depicts an example workflow for bounding box generation.

FIGS. 3A-3B depict a first example of generating a bounding box for extracted information.

FIGS. 4A-4C depict a second example of generating a bounding box for extracted information.

FIG. 5 depicts an example method of generating one or more bounding boxes for extracted information.

FIG. 6 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In some cases, generative artificial intelligence (AI) extraction models are used to automate information extraction workflows and extract relevant information from documents. Due to their capability to analyze and understand content, extract relevant information, and filter out noise, data extraction may be more efficient and accurate with the use of these models.

For example, a generative AI extraction model may be prompted to extract information in a document, such as a tax form. As a precursor step to extraction, optical character recognition (OCR) may convert the document to machine-readable text (referred to herein as “OCR data”). The generative AI extraction model may be used to uncover complex patterns, as well as identify correlations and trends within the OCR data. These intelligent data insights may facilitate the recognition of valuable information by the model, such as the information that the generative AI extraction model has been prompted to extract from the document. The generative AI extraction model may generate an output based on this information. The output may include the information requested to be extracted from the document.

In some cases, the extracted information includes a key-value pair included in the document. A key-value pair is a data type that consists of two related data elements: (1) a key that is an identifier for an associated value and (2) the associated value. For example, a document may include multiple predefined fields, which are placeholders for information. The name of a field may represent a key (also referred to herein as a “field key”) of a key-value pair, while the information entered into and associated with the field may represent a value (also referred to herein as a “field value”) of the key-value pair. A generative AI extraction model may be used to extract a field value for a field key corresponding to a key-value pair included in the document. The output generated by the generative AI extraction model may include the extracted field value.

Because generative AI extraction models are trained to generate completely original artifacts, the extracted information may or may not comprise exact information contained within the document, and more specifically the OCR data analyzed by the extraction model. To illustrate, consider an example document including the field key “Address” and the field value “123 Broadway Stret,” which corresponds to the field key. Here, the field value “123 Broadway Stret” is missing an “e” in “street” and is thus spelled incorrectly. A generative AI extraction model, prompted to extract the field value for the field key “Address,” may, in some cases, generate an output that does not match the field value included in the document exactly. For example, the generative AI extraction model may generate an output of “123 Broadway Street,” which corrects the misspelling of the field value included in the document, instead of generating “123 Broadway Stret” exactly. In another example, a generative AI extraction model may be fine-tuned to output data with a certain format. For example, the generative AI extraction model may be fine-tuned to output numbers formatted as dollar amounts (e.g., $1,234.56 or $1,234.00) even when the data in the document is not formatted in this way (e.g., 1234.5600 or 1234, respectively).

Extracted information (e.g., extracted via a generative AI extraction model) may be used in various downstream task(s) and/or application(s). For example, the extracted information may be processed and used to populate a form or database, used by downstream analytical tool(s), and/or displayed to a user, among other applications. In some cases, prior to using the extracted information in downstream processes(s), it may be beneficial to review and validate the extracted information for accuracy. For example, in any data-driven process relying on data extraction, the accuracy of the data extraction function is paramount. In high-risk industries (e.g., healthcare, finance, engineering, science, transportation, etc.), incorrectly extracted information may lead to serious injury, loss of life, loss of assets, destruction of property, legal liability, and the like. However, achieving this accuracy is a technically challenging task due to a multitude of factors that may influence the accuracy of information extracted from document(s). Example factors that may impact the accuracy include (1) the document and/or image quality (e.g., if an image of the document is used), (2) the document layout, (3) poor OCR data, (4) the inadequate training of generative AI extraction models, etc.

Instead of simply providing extracted information to a user for review and validation, a bounding box may be used to expedite review. A bounding box is an outline (e.g., a generally rectangular outline) generated around an item of interest (e.g., text, an object, and/or a region of interest) included in a document and/or an image. The bounding box may be generated on some display of the document. In this context, a bounding box is used to annotate a document or an image of a document to indicate where, in the document or in the image, the extracted information is located. Use of the bounding box may enable the user to efficiently review the extracted information for accuracy. For example, the user's attention may be drawn towards the bounding box generated on some display of the document such that the user is able to (1) efficiently identify where the extracted information was extracted from in the document, (2) if the extracted information matches the information included in the document, and (3) whether the extracted information is the information that was requested by the user. In certain embodiments, a user may perform this validation prior to the extracted information being used in downstream applications and/or tasks to beneficially help avoid a wide range of bad outcomes (e.g., due to the potential use of an inaccurate extracted field value).

Conventional bounding box generation techniques tend to work well for cases where the extracted information matches exactly, some information included in a document used for the extraction (and more specifically, exactly matches some text included in OCR data generated for the document). For example, it is easier to identify that an extracted field value of “300” corresponds to a field value of “300” in a document, than identifying that an extracted field value of “300” corresponds to a field value of “301” or a field value of “300.50” in a document. Put differently, the matching problem, for generating a bounding box in a document, may be less complex where the extracted information matches exactly some information included in the document.

As such, the ability of generative AI extraction models to extract information that does not match information included in a document, increases the complexity of the matching problem. Thus, generating bounding boxes for the extracted information may be more challenging. For instance, it is technically challenging to determine a location in a document for generating bounding box(es), to help expedite review of the extracted information, when the extracted information does not exactly match any of the information included in the document.

Conventional bounding box generation techniques also tend to work well for cases where the extracted information is unique and includes only one token. As used herein, a token is an individual character, numerical value, word, sub-word, phrase, or even larger linguistic unit included in, for example, a document used for extraction (e.g., extracted information of “John Smith” may include a first token for “John” and a second token for “Smith”). For example, extracted information that is unique and includes only one token may appear in only one location in a document used to extract the information. As such, determining where to generate a bounding box on a display of the document may be easily identified due to at least its correspondence to a single location in the document.

Extracted information that includes multiple tokens (e.g., a sequence of two or more tokens), however, presents a second technical challenge for conventional bounding box generation techniques. In particular, when information extracted from a document includes multiple tokens, then each token may correspond to a different location in the document. For example, extraction information “John Smith” may correspond to a first location in the document associated with token “John” and a second location in the document associated with the token “Smith.” Because the extracted information corresponds to multiple locations in the document, it may not be clear where a bounding box should be generated for the extracted information (e.g., on some display of the document).

Extracted information that does not include unique token(s) (e.g., a single unique token and/or multiple tokens that represent a unique phrase) presents a third technical challenge for conventional bounding box generation techniques. In particular, when extracted information includes a non-unique token, then this non-unique token may be associated with multiple locations in the document. Again, multiple locations in the document, corresponding to a token included in the extracted information, makes finding the exact location of the extracted information challenging, and in some cases impossible, for bounding box generation.

Embodiments described herein overcome the aforementioned technical problems and improve upon the state of the art by introducing techniques for generating bounding boxes for information extracted from a document. The information extracted may include one or more tokens (e.g., extracted information with multiple tokens may be referred to herein as a “sequence of tokens”) and, in some cases, includes token(s) that are (1) not included in the document and/or (2) are not unique. The bounding boxes may be generated on some display of the document to indicate a location of the extraction in the document. For example, the techniques described herein may be used to (1) identify information included in the document, represented as token(s), that is sufficiently “typographically close” (described in more detail below) to token(s) included in the extracted information. Further, the techniques may be used to (2) determine which of these token(s) included in the document are sufficiently “geometrically compact” (described in more detail below). Token(s) in the document that are sufficiently “typographically close” and sufficiently “geometrically compact” may represent token(s) in the document that “best” correspond to, or match, the token(s) included in the extracted information (referred to herein as “matched token(s)”). The location of the matched token(s) in the document may represent a location in the document where the information was (likely) extracted by a generative AI extraction model. A bounding box may be generated on some display of the document to outline and surround the matched token(s) in the document. As such, the bounding box, when displayed with the document, may help a user to more efficiently identify where, in the document, the generative AI extraction model extracted the information.

As used herein, “typographical closeness” refers to a degree of similarity (e.g., degree of lexical similarity) measured between (1) a first set of one or more tokens (e.g., token(s) in a document used for extraction) and (2) a second set of one or more tokens (e.g., token(s) included in information extracted from the document). The first set of tokens and second set of tokens may have a sufficient, typographical closeness (e.g., based on their lexical similarity) if their typographical closeness satisfies a typographical closeness threshold. Techniques for determining the typographical closeness between tokens are described in detail below.

Further, as used herein, “spatial compactness” defines how close and/or packed together two or more tokens are within a document used for extraction. A larger spatial compactness, measured between token(s) in the document may suggest that the token(s) are close to one another in the document (e.g., positioned near one another in the document), and the opposite may be true where a smaller spatial compactness is measured. In certain embodiments, a larger spatial compactness measured between token(s) may suggest that the token(s) cover a smaller area in the document. Token(s) in the document with sufficient, spatial compactness may satisfy a spatial compactness threshold. Techniques for determining the spatial compactness between tokens are described in detail below.

In certain embodiments, the extracted information includes multiple tokens and/or one or more token(s) that are not unique, meaning that the extracted information is included in the document more than once (as described above). For example, a first set of tokens (e.g., a set of tokens includes one or more tokens) and a second set of tokens may satisfy the spatial compactness threshold and the typographical closeness threshold (e.g., when compared to the extracted information). To determine which set of tokens (e.g., among the two or more sets of tokens) in the document corresponds to the extracted information, an identifier (e.g., such as a field key) for the extracted information may be used. For example, techniques herein may identify where, in the document, the identifier (e.g., field key) is located. The set of tokens in the document that satisfies some criteria based on the location of the identifier (e.g., a smallest distance to the location of the identifier) may represent the token(s) in the document that “best” correspond to, or match, the token(s) included in the extracted information.

The techniques described herein, for generating bounding boxes, thus provide significant technical advantages over conventional solutions, such as (1) improved accuracy and efficiency in generating bounding boxes and (2) the ability to generate bounding boxes for additional types of extracted information. For example, the techniques described herein enable the generation of bounding boxes for extracted information that comprises multiple tokens and/or token(s) which may be non-unique and/or may not be included in a document used for extraction. The techniques described herein may enable bounding box generation for these additional types of extracted information, while also helping to ensure that the bounding boxes generated accurately represent the locations of the extracted information in the document. For example, the techniques described herein seek to find “quality” matches of tokens in the document that are sufficiently typographically close to the extracted information and that are sufficiently geometrically compact within the document. The location of these tokens is then used to generate a bounding box.

Notably, the improved bounding box generation techniques described herein can further improve the function of any existing application that processes extracted information. For example, the techniques allow for the generation of bounding boxes for any type of extracted information to help expedite review (e.g., for accuracy) prior to the extracted information being processed by downstream application(s). In this way, the user reviewing the extracted information for accuracy can more easily identify where the extracted information is pulled from in the document, and in some cases, adjust the extracted information when it is extracted incorrectly. Adjustment of erroneously extracted information, prior to use in downstream application(s), helps to avoid any problems that would have otherwise been created by use of this erroneous information downstream.

### Example System Implementing a Bounding Box Generator

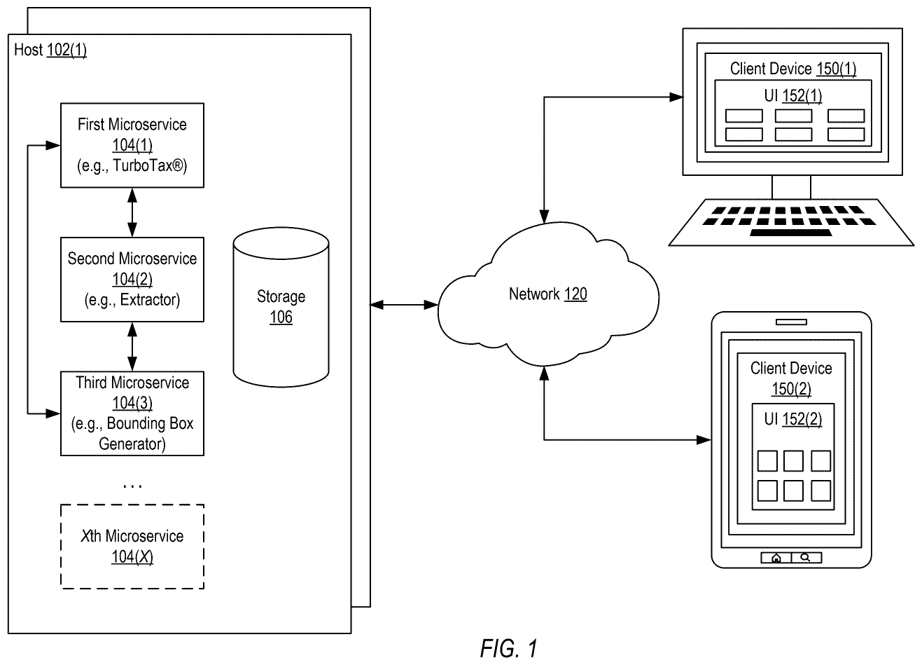

FIG. 1 depicts an example system 100 having an extractor and a bounding box generator, each implemented as a software-defined service (e.g., in some cases, a cloud-native software-defined service), also referred to herein as “a microservice 104.” Generally, microservices 104 are loosely coupled and independently deployable services (or software) that may make up an application. Microservices 104 may enable segmented, granular level functionalities within a larger system infrastructure.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface (UI) 152(1), 152(2), respectively, which may be used to communicate with, at least, a first microservice 104(1), a second microservice 104(2), and/or a third microservice 104(3) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, the first microservice 104(1), the second microservice 104(2), and the third microservice 104(3). In certain embodiments, the first microservice 104(1) implements an information service, which is any network 120 accessible service that maintains financial data, medical data, personal identification data, and/or other data types. For example, the information service may include TurboTax® and its variants made commercially available by Intuit® of Mountain View, California.

In certain embodiments, the second microservice 104(2) implements an information extraction service. The information extraction service (or “extractor”) may be a service used to perform automated information extraction from one or more documents stored and/or made available by the information service. In certain embodiments, the information extraction service implemented by second microservice 104(2) is configured to extract one or more field values for one or more field keys of one or more documents. In certain embodiments, the information extraction service utilizes a generative AI extraction model to perform extraction. In certain embodiments, the information extraction service may provide and/or make available the extracted field values(s) and/or field key(s) to third microservice 104(3).

The third microservice 104(3) may implement a bounding box generator service. In certain embodiments, the bounding box generator service (or “bounding box generator”) implemented by third microservice 104(3) is configured to generate bounding box(es) in a document for information extracted from the document. For example, the bounding box generator may be configured to first match extracted token(s) (e.g., together representing “extracted information”) from a document to a set of (e.g., one or more) OCR tokens included in OCR data generated for a document based on, for example, typographical closeness and spatial compactness thresholds). The bounding box generator may be further configured to then generate a bounding box for the extracted token(s) in the document based on the identified set of OCR tokens matching the extracted token(s). In one example, the bounding box generator may use a location of the identified set of OCR tokens to determine a location of an output bounding box in the document that is to be generated for the extracted token(s). In certain embodiments, the bounding box generator is configured to generate the output bounding box for display on client device 150(1) and/or client device 150(2) with some display of the document, via user interface 152(1) and user interface 152(2), respectively. Display of the output bounding box on client device 150(1) and/or client device 150(2) may allow a user to more efficiently review and validate the accuracy of the extracted token(s). For example, display of the output bounding box may enable a user to (1) efficiently identify where the extracted token(s) were extracted from in the document, (2) if the extracted token(s) match the information included in the document, and/or (3) whether the extracted token(s) represent token(s) associated with a requested field key or a field value in the document.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for Automatic Information Extraction and Bounding Box Generation

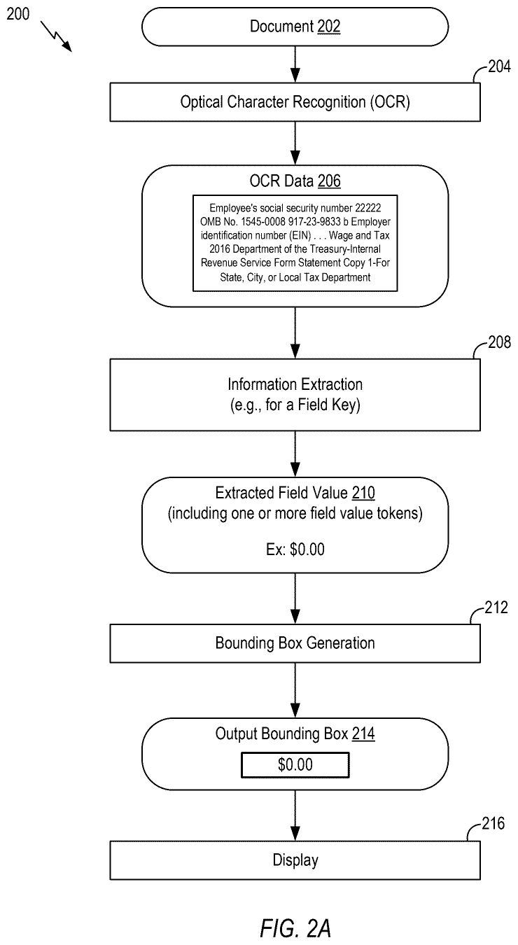

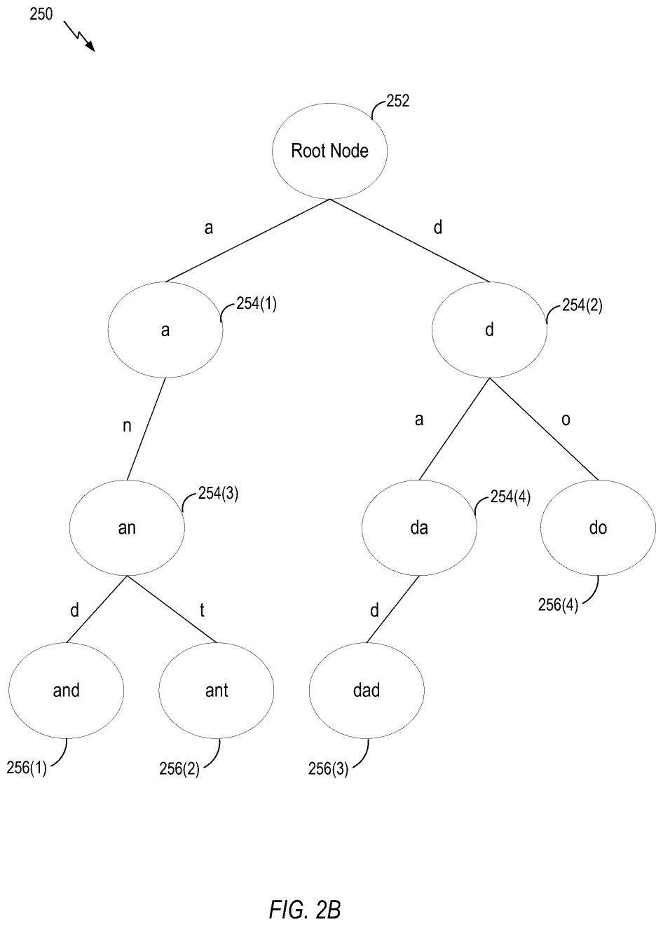

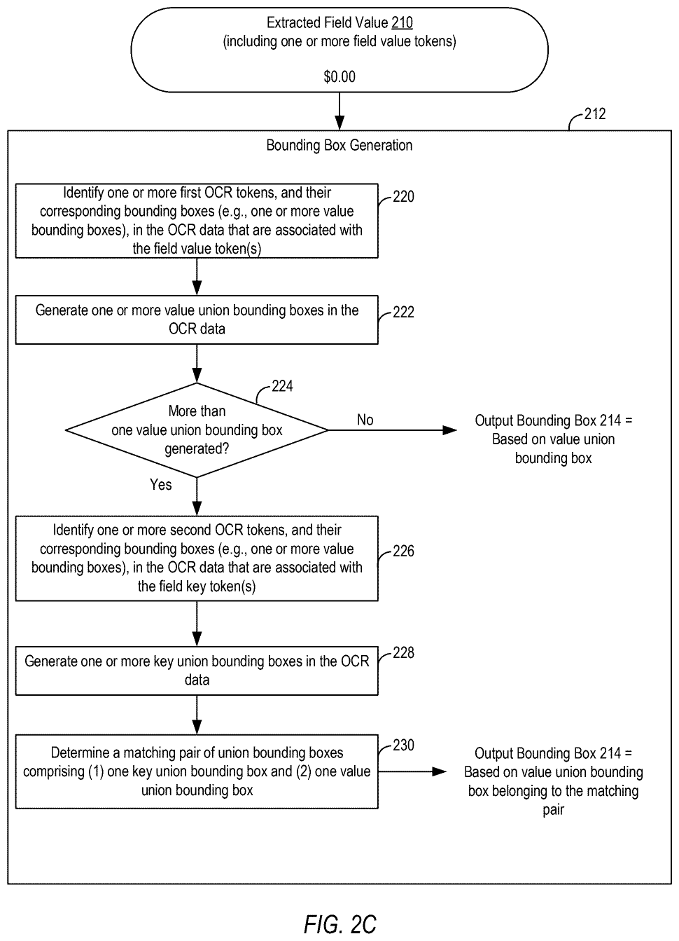

FIGS. 2A-2B depict an example workflow 200 used to extract information from a document and to generate a bounding box (referred to herein as an “output bounding box”) for the extracted information. More specifically, the document may include multiple key-value pairs, and workflow 200 may be used to extract a field value for a field key included in the document. Further, workflow 200 may be used to generate an output bounding box for the field value. The output bounding box may be generated on some display with the document to define an area in the document where the field value was extracted.

In certain embodiments, document 202 may be an unstructured document, or a free-form document that does not have a set structure, format, and/or a pre-defined number and/or type of fields. In certain embodiments, document 202 may be a structured document, or a document where the layout, type of fields, and/or number of fields included in the document is consistent (e.g., forms, bills, payment slips, etc.). In particular, a structured document may use a pre-defined and expected format with a pre-defined set of fields.

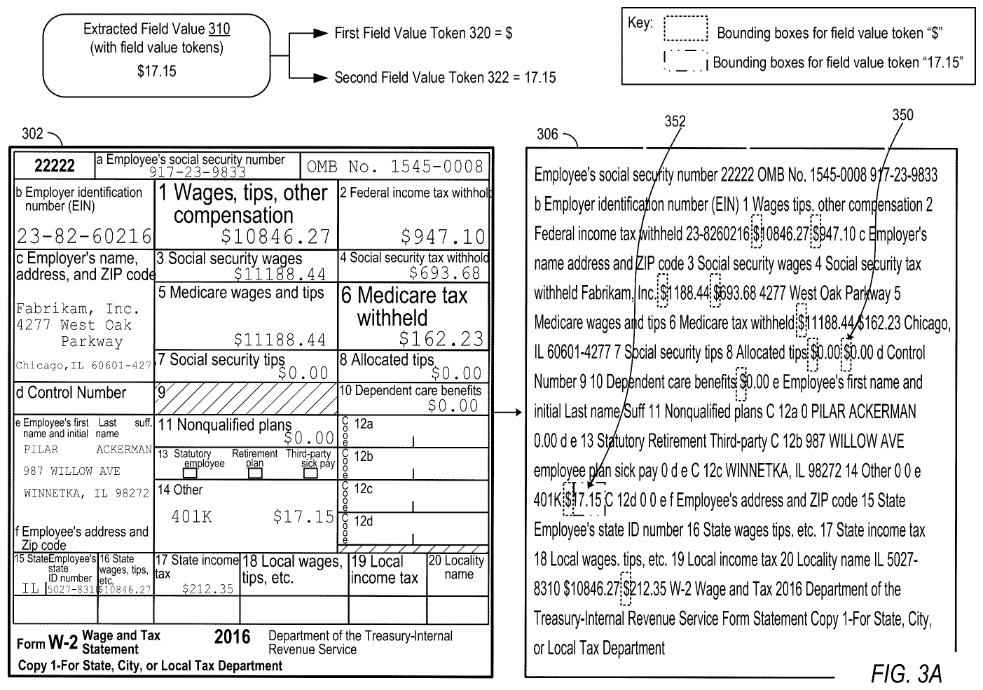

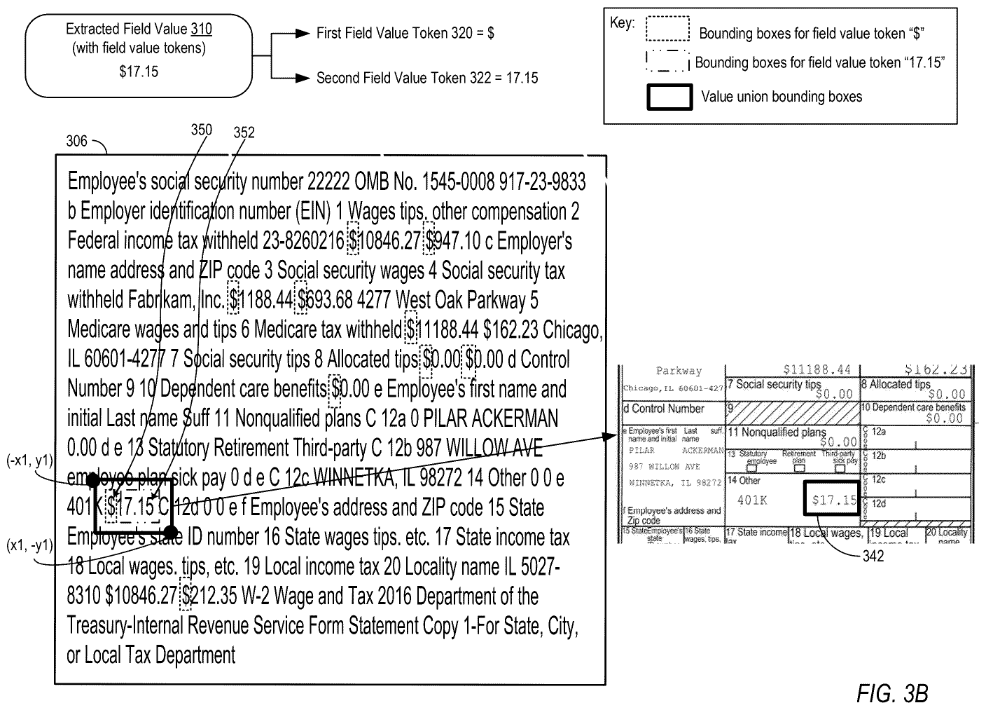

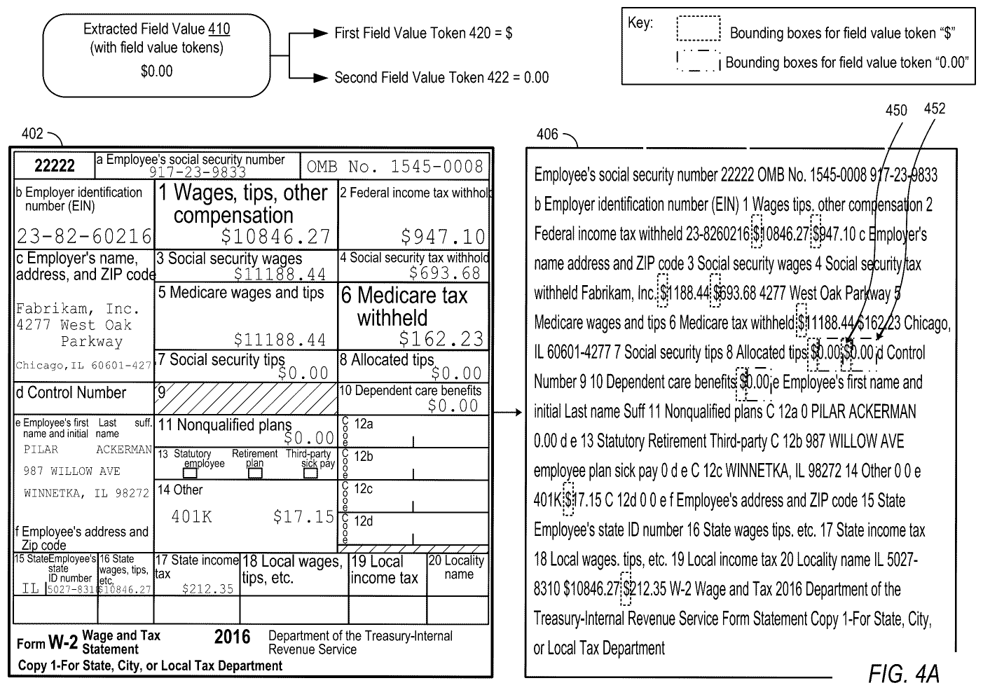

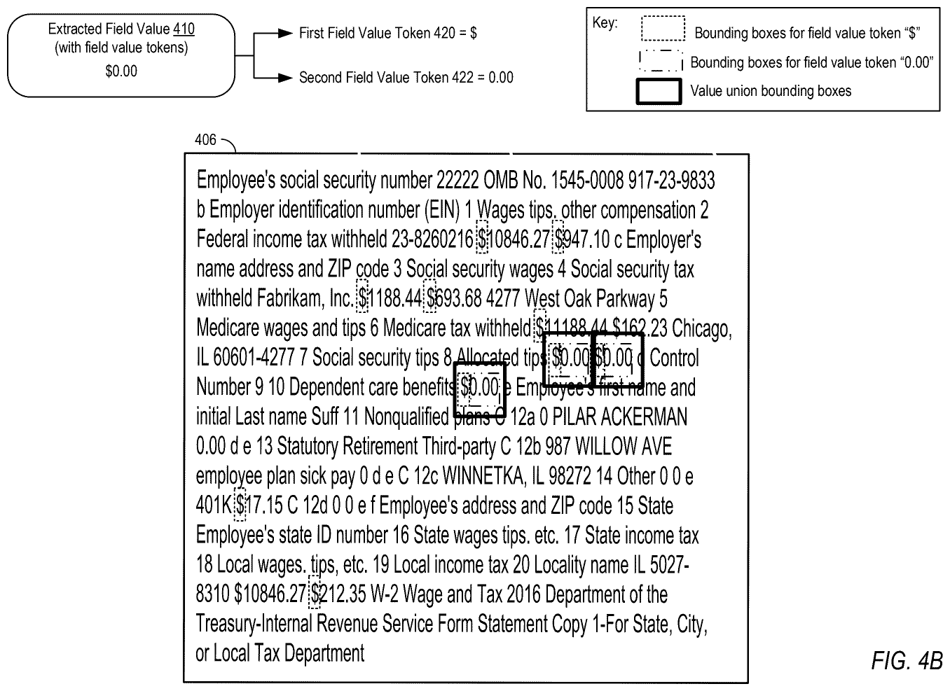

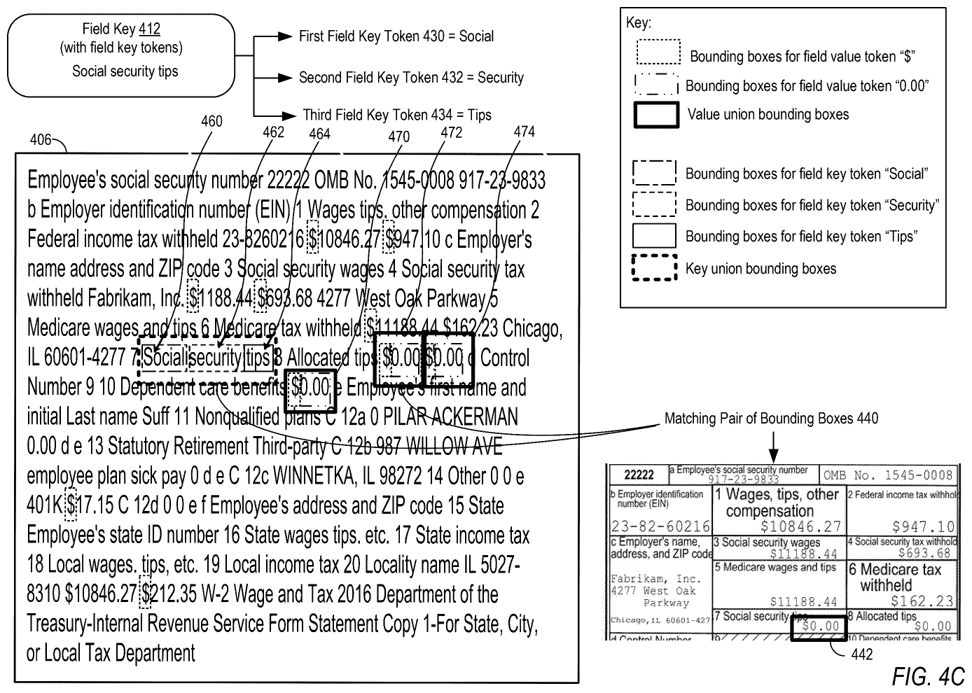

As one example, document 202 may be an example IRS Form W-2 including information for an employee, such as document 302 and document 402 including information for an employee, Pillar Ackerman, as shown in FIGS. 3A and 4A, respectively. Document 202 may include pre-defined fields, also referred to herein as “field keys,” such as a “Wages, tips, and other compensation” field key and a “Medicare tax withheld” field key,” among others (e.g., as shown in document 302 in FIG. 3A and in document 402 in FIG. 4A). Fields in document 202 may include information, also referred to as “field values,” entered for each respective field key. For example, document 302 in FIG. 3A and in document 402 in FIG. 4A, a field value “10846.27” may be entered for the “Wages, tips, and other compensation” field key, and a field value “162.23” may be entered for the “Medicare tax withheld” field key, among others.

In certain embodiments, document 202 represents a hard copy or a soft copy (e.g., without recognized text) of a document. Thus, to begin the extraction process illustrated by workflow 200, in certain embodiments, document 202 is scanned to generate a digital version of document 202 that may be processed by workflow 200. In certain embodiments, a photograph of document 202 may be taken and uploaded for processing via workflow 200. In some cases, the scan or photo is captured by a user's mobile device either indirectly (e.g., via a scanning or camera application), or within a native application running on the mobile device for which the extracted information is meant to be used. Further, other suitable methods for generating a digital copy of document 202 may be performed.

Although workflow 200 is described with respect to the extraction of a field value for a field key in an IRS Form W-2, steps in workflow 200 may be similarly applied to extract field value(s) for field key(s) in other documents and generate bounding box(es) for the extracted field value(s).

OCR 204 includes performing OCR on document 202 to generate OCR data 206 for use in an application. For example, OCR 204 may include processing document 202 by locating and recognizing tokens in document 202. OCR 204 may then further include converting the recognized tokens to a machine-readable text format (e.g., OCR data 206) that may be understood, for example, by a generative AI extraction model. OCR data 206 may include raw text from document 202 and/or one or more key-value pairs identified during OCR 204. As such, OCR data 206 may include one or more tokens from document 202. Additionally, OCR data 206 may include coordinates for one or more bounding boxes. The bounding box(es) may enclose individual tokens in OCR data 206. Further, in certain embodiments, OCR data 206 may include geometric information associated with document 202. The geometric information may include information about the positions of different tokens in document 202.

Example OCR data 206 that may be generated for a document 202 includes OCR data 306 generated for document 302 in FIG. 3A and OCR data 406 generated for document 402 in FIG. 4A. As shown in FIGS. 3A and 4A, OCR data 306, 406 may include the raw text from document 302 or document 402, respectively. Field keys and field values included in document 302, 402 are included as tokens in a plurality of rows in OCR data 306, 406, respectively. Although not shown, geometric information included in OCR data 306, 406 may include information about a first position of the field key “Wages, tips, other compensation” and a second position of the field value “10846.27” in document 302, 402. As described herein, this position information may be used by a bounding box generator (e.g., the bounding box generator implemented as a third microservice 104(3) in FIG. 1) when generating a bounding box for information extracted from document 302, 402.

Information extraction 208 includes extracting a field value for a field key in document 202. Information extraction 208 may be performed by an information extraction service, implemented as second microservice 104(2) in FIG. 1 that utilizes a generative AI extraction model. For example, information extraction 208 may involve prompting the generative AI extraction model to extract an extracted field value 210 for a requested field key in document 202. The generative AI extraction model may perform the extraction using OCR data 206. The extracted field value 210 may include one token or a sequence of multiple tokens. A single token that is extracted may be referred to as a “field value token.” Alternatively, if a sequence of multiple tokens is extracted, each token in the sequence may be referred to herein as a “field value token.” The field value token(s), associated with extracted field value 210, together may be unique or non-unique. Each field value token, individually, may be a unique or non-unique token. Each field value token may include a token found in OCR data 206 or a token not found in OCR data 206.

For example, during information extraction 208, a generative AI extraction model may use OCR data 206 to extract a field value of “Hawaii” for a field key of “State” included in document 202. In document 202 and similarly OCR data 206, the field value associated with field key “State” may be correctly spelled as “Hawaii”; thus, the extracted field value token may match exactly the field value token included in document 202 and OCR data 206. In some other cases, the field value associated with field key “State” in document 202, and similarly OCR data 206, may be incorrectly spelled as “Hawai,” thereby missing the second “i.” For example, a nuance of using a generative AI extraction model is the ability to generate “Hawaii” based on reading “Hawai” (e.g., missing the “i”). As such, the extracted field value token, “Hawaii,” may not exactly match the field value token included in document 202 and OCR data 206. Although in this example, the extracted field value token and the field value token included in document 202 and OCR data 206 are different based on some misspelling, in some other examples, the extracted field value token(s) may be different than token(s) included in document 202 and OCR data 206 for one or more other reasons.

Bounding box generation 212 is performed to generate an output bounding box 214 in document 202 for the extracted field value. For example, bounding box generation 212 may be performed to identify token(s) in document 202, and more specifically, OCR token(s) in OCR data 206 that are (1) sufficiently, typographically close (e.g., satisfy a typographical closeness threshold) to field value token(s) included in the extracted field value 210 and (2) are sufficiently, geometrically compact (e.g., satisfy a spatial compactness threshold). OCR token(s) that satisfy these thresholds may represent OCR tokens in OCR data 206 that “best” correspond to, or match, the field value token(s) in extracted field value 210.

In certain embodiments, “typographical closeness” may refer to a degree of similarity (e.g., degree of lexical similarity) measured between (1) field value token(s) (e.g., associated with extracted field value 210) and (2) OCR token(s) in OCR data 206. A maximum typographical closeness (or a maximum degree of similarity) determined between field value token(s) and OCR token(s) may suggest that there is a minimum edit distance (e.g., edit distance=0) between the field value token(s) and the OCR token(s) (e.g., an exact match). On the other hand, a minimum typographical closeness (or a minimum degree of similarity) determined between field value token(s) and OCR token(s) may suggest that there is a maximum edit distance between field value token(s) and the OCR token(s).

As used herein, an edit distance, also referred to as “Levenshtein distance,” refers to the number of single-character edits required to convert a first set of tokens (e.g., one or more tokens) into a second set of tokens. The single-character edits may include insertions (e.g., adding a single character), deletions (e.g., removing a single character), and/or substitutions (e.g., replacing a single character). Each edit performed is counted to determine the edit distance between two sets of tokens. In certain embodiments, a larger edit distance between field value token(s) and OCR token(s) may indicate less similarity between the field value token(s) and the OCR token(s) being compared.

In certain embodiments, an edit distance between field value token(s) and OCR token(s) is compared against a threshold to determine if the field value token(s) and the OCR token(s) are typographically close. For example, if the edit distance is above the threshold, then the OCR token(s) may not be typographically close to the field value token(s). In certain embodiments, the threshold may be a function of a length of the tokens being compared. For example, in certain embodiments, the threshold may be calculated as:

$$threshold = ceil ( min ( len ( seq\_a ) , len ( seq\_b ) ) * 0.2 )$$

where len(seq_a) refers to a length of the field value token(s) and len(seq_b) refers to a length of the OCR token(s) being compared. For example, an OCR token may be “1234567890123456,” with a length of 16, and a field value token may be “1223456789,” with a length of 10. Thus, the minimum length may be 10, and using the above equation, the threshold may be equal to 2 (e.g., threshold=ceil (10*0.2)=2. A threshold of 2 may indicate that an edit distance between the OCR token and the field value token may need to be equal to 2 or less to find that the OCR token and field value token are typographically close.

At least one OCR token may be identified as being typographically close to field value token(s) associated with extracted field value 210.

In certain embodiments, a trie data structure is used to aid the search for typographically close OCR token(s) in OCR data 206. For example, a trie data structure, also referred to as a “prefix tree” or simply a “trie,” is a tree-like data structure used to compactly store OCR tokens that can be visualized. An example trie data structure 250 is illustrated in FIG. 2B.

As shown, trie data structure 250 consists of a root node 252, intermediate nodes 254(1)-(4) (collectively referred to herein as “intermediate nodes 254”), and end-nodes 256(1)-(4) (collectively referred to herein as “end-nodes 256”). Root node 252, intermediate nodes 254, and end-nodes 256 may be connected by edges. Root node 252, the starting point of the trie data structure 250, represents an empty token (or empty string). Each intermediate node 254 represents a character or a part of an OCR token. Each end-node 256 represents a set of OCR tokens in OCR data 206. For example, one end-node 256 may include a single OCR token, such as “Houston,” while another end-node 256 may include a sequence of multiple OCR tokens, such as “New York City.” The path from root node 252 to an intermediate node 254 represents the prefix of an OCR token or a sequence of multiple OCR tokens stored in trie data structure 250. Accordingly, each OCR token or sequence of multiple OCR tokens (represented as end-nodes 256) can be retrieved by traversing down a branch of the trie data structure 250.

In certain embodiments, a trie data structure, similar to trie data structure 250 in FIG. 2B, is created and used to provide an efficient way to compare field value token(s) (e.g., associated with extracted field value 210) and OCR token(s) in OCR data. For example, the trie data structure may allow for the reuse of common prefixes among the OCR tokens (or sequences of multiple OCR tokens) used to create the trie data structure. An edit distance between a prefix of a given branch in the trie data structure and the field value token(s) may be computed. If the computed edit distance is greater than a threshold (e.g., indicating a larger edit distance), then the branch may be skipped. Skipping the branch may include skipping determining the edit distance between the field value token(s) and each of the OCR token(s) in (e.g., associated with) the skipped branch of the trie data structure (e.g., edit distances may be computed for less than all OCR tokens). As such, use of the trie data structure beneficially saves computational time and resources, thereby improving efficiency of the search for typographically close OCR token(s) to extracted field value token(s).

In certain embodiments, after completing workflow 200, including after (1) identifying OCR token(s) that correspond to the extracted field value token(s) (e.g., ascribing OCR token(s) to the extracted field value token(s)) and (2) generating an output bounding box based on the identified OCR token(s), the identified OCR token(s) may be removed from the trie data structure. By removing these OCR token(s) from the trie data structure, the number of OCR tokens included in the trie data structure may be reduced. Pruning the trie data structure in this way to remove such OCR token(s) helps to speed up subsequent searches, as well as prevent OCR token(s) from being reused (e.g., OCR token(s) being matched to more than one extracted field value when the extracted field values are different).

In certain embodiments, “spatial compactness” may define how close and/or packed together two or more OCR tokens are based on geometric information associated with these OCR tokens. For example, OCR data 206 may include geometric information for tokens included in document 202 used to create OCR data 206. The geometric information may include information about the positions and/or locations of different tokens in the document 202, which are represented as OCR tokens in the OCR data 206. A spatial compactness between a first set of OCR tokens and a second set of OCR tokens may be based on geometric information for a first set of tokens in the document represented as the first set of OCR tokens in the OCR data and geometric information for a second set of tokens in the document represented as the second set of OCR tokens in the OCR data. A larger spatial compactness (indicating a greater degree of geometrical closeness and/or togetherness) determined between the first and second sets of OCR tokens may suggest that the first and second set of tokens in the document 202 are next to each other within the document 202. On the other hand, a smaller spatial compactness determined between the first and second sets of OCR tokens may suggest that the first and second sets of tokens in the document 202 are not next to (e.g., not close to) each other within the document 202.

In certain embodiments, spatial compactness is determined between OCR token(s) having sufficient typographical closeness to the field value tokens. As an illustrative example, an extracted field value 210 may include three tokens, such as “New,” “York,” and “City.” Per the techniques described herein, a first spatial compactness may be determined between (1) OCR token(s) determined to be typographically close to “New” and (2) OCR token(s) determined to be typographically close to “York.” Further, a second spatial compactness may be determined between (1) OCR token(s) determined to be typographically close to “New York, as well as geometrically compact, and (2) OCR token(s) determined to be typographically close to “City.” As such, in certain embodiments, identifying typographically close and spatially compact OCR tokens may be performed simultaneously to identify OCR tokens that meet these criteria. OCR tokens(s) that are typographically close to the field value token(s) and are geometrically compact may be “ascribed to,” or determined to likely be associated with, the field value token(s).

In certain embodiments, a single OCR token is determined to be typographically close to an extracted field value. A single OCR token may be “geometrically compact” with itself and thus “ascribed to,” or determined to likely be associated with, the field value token(s).

Bounding box generation 212 may additionally include generating an output bounding box 214, for display with document 202, based on the identified OCR token(s) and geometric information included in OCR data 206 for these identified OCR token(s). Additional details regarding bounding box generation 212 are provided below with respect to FIG. 2C.

Display 216 includes displaying output bounding box 214. Output bounding box 214 may be displayed on a computing device, such as client device 150(1) and/or client device 150(2) depicted in FIG. 1. Output bounding box 214 may be displayed with document 202, such that output bounding box 214 completely surrounds token(s) in document 202 corresponding to the OCR token(s) identified, during bounding box generation 212, as matching the extracted field value token(s). Thus, output bounding box 214 and document 202 may be displayed together during display 216. Displaying output bounding box 214 with document 202 may allow a user to quickly identify where the extracted field value 210 was extracted from in document 202 such that the user may review and validate the accuracy of the extracted field value, in some cases, prior to its use in downstream application(s) and/or task(s).

For example, in certain embodiments, an application may use extracted field value 210 to populate a form. As an illustrative example, a tax application may use the extracted field value 210 to populate “Gross income,” “Tips,” etc. field(s) of a tax return.

Although workflow 200 describes steps related to the automatic extraction of a single field value for a single field key, and thus the generation of a single output bounding box for the single field value, in certain other embodiments, workflow 200 may be used to extract multiple field values for multiple field keys and to generate an output bounding box for each extracted field value.

FIG. 2C depicts example steps for performing bounding box generation 212 in workflow 200, presented in FIG. 2A. As shown, bounding box generation 212 begins after an extracted field value 210 has been extracted (e.g., at information extraction 208 in FIG. 2A).

Bounding box generation 212 begins, at block 220, with identifying one or more first OCR tokens and their corresponding bounding boxes (e.g., referred to herein as “one or more value bounding boxes”) in OCR data 206 (e.g., shown in FIG. 2A). The first OCR token(s) and the value bounding box(es) are associated with the field value token(s) belonging to extracted field value 210. For example, the first OCR token(s) may be “associated with” the field value token(s) based on (1) the first OCR token(s) satisfying a typographical closeness threshold (e.g., either individually and/or one or more of the first OCR token(s) together) and (2) value bounding box(es) associated with one or more of the first OCR token(s) satisfying a spatial compactness threshold. Put differently, the first OCR token(s) in OCR data 206 may be token(s) that (e.g., individually and/or one or more together) are sufficiently similar to the field value token(s) in extracted field value 210. Further, the first OCR token(s) may each be associated with a value bounding box that individually is determined to be geometrically compact or when compared to one or more other value bounding boxes is determined to be geometrically compact.

As described herein, an edit distance between OCR token(s) and field value token(s) may be used to determine whether the OCR token(s) are sufficiently typographically close to the field value token(s). The value bounding box(es) may include a bounding box surrounding each of the first OCR token(s).

In certain embodiments, a trie data structure (e.g., such as trie data structure 250 illustrated in FIG. 2B) is used to identify the first OCR token(s) associated with the field value token(s) belonging to extracted field value 210. For example, the plurality of OCR tokens in the OCR data may be represented in a trie data structure, where each OCR token (or sequence of multiple OCR tokens) can be retrieved by traversing down a branch path of the tree. The trie data structure may be used to determine the OCR tokens to compute an edit distance for and those OCR tokens for which calculating an edit distance for can be skipped. For example, OCR tokens that do not have a same prefix as one or more of the field value token(s) may be skipped, given the edit distance calculated for these OCR tokens is likely to be high when calculated, thereby indicating these OCR tokens are likely not similar. For example, a branch in the trie data structure for OCR tokens “dad,” “dab,” and “dog” may be skipped when the extracted field value token is “pig,” given the prefixes “p” and “pi” do not match the prefixes “d,” “da,” and “do” for OCR tokens “dad,” “dab,”, and “dog.” The edit distance calculated for less than all OCR tokens in the OCR data may be used to identify which OCR tokens are associated with the field value tokens in extracted field value 210.

In certain embodiments, domain knowledge is considered when determining the “compactness” of OCR tokens. Example domain knowledge may include: knowledge that English is generally written in top-to-bottom and left-to-right fashion; knowledge that tokens in a document, such as a structured form, may be grouped together in blocks of text that may be made of multiple lines in the document; knowledge that blocks of text, in a document, may or may not have the first line of text indented; knowledge that blocks of text may or may not have subsequent lines of text (other than the first line) indented; knowledge that a vertical distance between lines of text, that belong to the same block of text, is much less than a vertical distance between lines of text that are not in the same block of text; and/or knowledge that the last tokens for all rows in a block of text have coordinates that are in the vicinity on a same x-dimension/extent, with only the y-dimension changing.

Bounding box generation 212 then proceeds, at block 222, with generating one or more value union bounding boxes in the OCR data. A value union bounding box may create a “union” for one or more of the first OCR tokens (e.g., in some cases, a “union” may be created for only one first OCR token), and their corresponding value bounding box(es). In general, a “union bounding box” may refer to a bounding box, constructed based on bounding box(es) associated with one or more OCR tokens, which surrounds/encloses the bounding box(es) (e.g., creates a larger bounding box that unites/associates the bounding box(es) associated with the one or more OCR tokens). For example, as shown in FIG. 3B, a value union bounding box is used to create a union between OCR token 350 and OCR token 352, and their corresponding bounding boxes. More specifically, each value union bounding box may join OCR token(s) among the first OCR tokens that are geometrically compact (e.g., are associated with bounding box(es) that are geometrically compact). In some cases, one first OCR token may be determined to be “geometrically compact” with itself. In some cases, two or more first OCR tokens may be “geometrically compact” if they are sufficiently close to one another and satisfy a spatial compactness threshold.

In some embodiments, the spatial compactness of a set of bounding boxes is computed in terms of the areas of the bounding boxes and a union bounding box constructed based on the bounding boxes. For example, the spatial compactness can be expressed as an intersection-over-union (IOU), i.e. the sum of the areas of the individual bounding boxes divided by the area of the union bounding box. A higher IOU may indicate greater spatial compactness. In some embodiments, the IOU for a set of bounding boxes may be compared with a threshold (e.g. 0.1, 0.2, 0.5, 0.9) to determine whether the bounding boxes meet a spatial compactness criterion. In general, a candidate union bounding box can be constructed around a set of smaller bounding boxes to determine whether the set is spatially compact.

In certain embodiments, each value union bounding box may include one first OCR token associated with each of the field value tokens in extracted field value 210. For example, if an extracted field value “$0.00” includes a first field value token “$” and a second field value token “0.00,” then each value union bounding box may include one first OCR token that is associated with the field value token “$” and another first OCR token that is associated with the field value token “0.00.” Put differently, the value union bounding box may surround a quantity of bounding boxes/OCR tokens equal to a quantity of the field value tokens (e.g., if extracted field value 210 includes two field value tokens, then the value union bounding box may be created to surround two bounding boxes/two OCR tokens).

In certain embodiments, identifying first OCR token(s) that are typographically close to the field value token(s) and which have bounding box(es) that are geometrically compact, to generate a value union bounding box, involves performing an iterative process. This iterative process may be performed when the extracted field value includes more than one field value token. For example, the iterative process may begin by, for a first field value token of the extracted field value, (1) identifying a first subset (e.g., one or more) of OCR tokens in the OCR data that are typographically close to the first field value token, (2) identifying a first subset of bounding boxes in the OCR data associated with the first subset of OCR tokens, and (3) setting a current set of bounding boxes to includes the first subset of bounding boxes. Further, for each additional field value token included in the extracted field value, the current set of bounding boxes may be reset (e.g., changed). For example, for a second field value token of the extracted field value, the iterative process continues with (1) identifying a second subset of OCR tokens in the OCR data that are typographically close to the second field value token, (2) identifying a second subset of bounding boxes in the OCR data associated with the second subset of OCR tokens, (3) identifying at least one bounding box in the second subset of bounding boxes that satisfies a spatial compactness threshold when combined with at least one bounding box in the current set of bounding boxes, and (4) resetting the current set of bounding boxes to include the at least one bounding box in the second subset of bounding boxes and the at least one bounding box in the current set of bounding boxes. Similar steps may be performed for each remaining field value token of the extracted field value. The final current set of bounding boxes may include value bounding boxes for which a value union bounding box is generated to surround.

As an illustrative example, an extracted field value may include two tokens “New York.” For the first field value token “New,” the iterative process may begin by identifying a first subset of OCR tokens in the OCR that are typographically close to the token “New.” In this example, three OCR tokens may be identified; thus, the first subset of bounding boxes may include three bounding boxes in the OCR data (e.g., each associated with one of the three OCR tokens in the first subset of OCR tokens). The current set of bounding boxes may be set to include the three bounding boxes in the first subset of bounding boxes. The iterative process may then continue by identifying a second subset of OCR tokens in the OCR data that are typographically close to the token “York.” In this example, three OCR tokens may be identified (e.g., each being typographically close to the token “York”); thus, the second subset of bounding boxes may include another three bounding boxes in the OCR data (e.g., each associated with one of the three OCR tokens in the second subset of OCR tokens). Only one of the three bounding boxes (e.g., a first bounding box) in the current set of bounding boxes, when combined with only one bounding box (e.g., a second bounding box) in the second subset of bounding boxes, may satisfy the spatial compactness threshold. Thus, the current set of bounding boxes may be reset to include only the first bounding box and the second bounding box. Then a value union bounding box may be generated to surround the first bounding box and the second bounding box. Specifically, the first bounding box and the second bounding box may satisfy the spatial compactness threshold, and OCR tokens associated with the first bounding box and the second bounding box may be typographically close to the field value tokens “New York.”

Bounding box generation 212 then proceeds, at block 224, with determining if more than one value union bounding box was generated at block 222. For example, if extracted field value 210 includes a unique token or unique sequence of multiple tokens in document 202, and similarly OCR data 206, then one value union bounding box may be generated. In other words, only one set of first OCR tokens in OCR data 206 may satisfy the typographical closeness and compactness thresholds (as shown in the example illustrated in FIGS. 3A-3B). On the other hand, if extracted field value 210 does not include a unique sequence of tokens in document 202, and similarly OCR data 206, then more than one value union bounding box may be generated (e.g., as shown in the example illustrated in FIGS. 4A-4C).

If only one value union bounding box is generated, then an output bounding box 214 may be generated based on the single value union bounding box. An example of this scenario is illustrated in FIGS. 3A-3B.

In FIG. 3A, an extracted field value 310 of “$17.15” is extracted from a document 302 (e.g., an IRS W-2 Form). For example, a generative AI extraction model may be used to extract extracted field value 310 of “$17.15” for a field key “Other,” shown in box 14 in document 302. The generative AI extraction model may use OCR data 306, generated for document 302, to perform the extraction of extracted field value 310. Extracted field value 310 of “$17.15” may include a first field value token 320 (simply “token 320”) of “$” and a second field value token 322 (simply “token 322”) of “17.15.”

As shown in OCR data 306, ten OCR tokens 350 (e.g., each with a corresponding dotted bounding box, as shown in FIG. 3A) may be identified as being associated with token 320, “$.” For example, a typographical closeness between token 320, “$,” and each OCR token 350 may satisfy (e.g., be greater than) a typographical closeness threshold, indicating that each OCR token 350, in OCR date 306, has sufficient similarity to token 320, “$.” Similarly, one OCR token 352 (with content “17.15”) (e.g., with a corresponding dotted and line bounding box, as shown in FIG. 3A) may be identified as being associated with token 322, “17.15.” For example, a typographical closeness between token 322, “17.15,” and OCR token 352 may satisfy (e.g., be greater than) the typographical closeness threshold, indicating that OCR token 352, in OCR data 306, has sufficient similarity to token 322, “17.15.”

In FIG. 3B, a value union bounding box is generated based on OCR data 306 (i.e., the bounding boxes of the OCR tokens ascribed to the extracted field value). The value union bounding box may be generated to surround (1) one of the OCR tokens 350 associated with token 320, “$” and (2) one of the OCR tokens 350 associated with token 322, “17.15.” Because there is only one OCR token 350 associated with token 322, “17.15,” then only one value union bounding box is created in OCR data 306. The value union bounding box may be created based on the OCR token 350 and the OCR token 352, shown in FIG. 3B, satisfying a spatial compactness threshold, indicating that OCR token 350 and OCR token 352 are sufficiently close together in document 302. In certain aspects, the value union bounding box may be created to cover the maximum extent in the x-direction and y-direction (e.g., along an x-axis and a y-axis, respectively) of the bounding boxes associated with OCR token 350 and OCR token 352.

In certain embodiments, the value union bounding box may be generated using the corner coordinates of bounding boxes for one of the OCR tokens 350 and one of OCR tokens 352. For example, in an x-y coordinate system, a first bounding box associated with an OCR token 350 may extend X1 in the x-direction (e.g., along an x-axis) and Y1 in the y direction (e.g., along a y-axis). Further, a second bounding box associated with an OCR token 352 may extend X2 in the x-direction and Y2 in the y-direction. An top left corner of the value union bounding box created for the first and second bounding boxes may be associated with a point at (min (X1, X2), max (Y1, Y2)). Further, a bottom right corner of the value union bounding box created for the first and second bounding boxes may be associated with a point at (max(X1, X2), min(Y1,Y2)).

In certain embodiments, the coordinates of the value union bounding box may be specified with respect to the coordinate of its top left and bottom right points (e.g., top left and bottom right corners). For example, the x and y coordinates of the top left point of the value union bounding box, with respect to the center of the value union bounding box (e.g., the point of origin or the centroid of the value union bounding box), may be defined as (−x1, y1). Further, the x and y coordinates of the bottom right point of the value union bounding box, with respect to the center of the value union bounding box, may be defined as (x1, −y1). The point of origin (e.g., corresponding to the centroid of the value union bounding box) may be based on geometric information (e.g., position information) associated with OCR token 350 and OCR token 352. In certain embodiments, the point of origin, the coordinates (−x1, y1) for the top left corner of the value union bounding box, and the coordinates (x1, −y1) for the bottom right corner of the value union bounding box are used to generate an output bounding box 342 for display with document 302. As shown, output bounding box 342 may be generated as an outline (e.g., generally rectangular outline) surrounding tokens in the document corresponding to OCR tokens 350, 352 surrounded by the value union bounding box in OCR data 306.

In certain embodiments, the coordinates (−x1, y1) for the top left corner of the value union bounding box, and the coordinates (x1, −y1) for the bottom right corner of the value union bounding box are relative to dimensions of document 302, when it was used to create OCR data 306. A such, if document 302 is re-sized prior to generation of the output bounding box 342, then the output bounding box 342 can be re-sized accordingly based on the new dimensions of the document 302.

Returning to workflow 200 in FIG. 2C, in some cases at block 224, more than one value union bounding box is generated. This may occur when the location from which extracted field value 210 is extracted is unknown or ambiguous. In such a case, bounding box generation 212 proceeds, at block 226, with identifying one or more second OCR tokens and their corresponding bounding box(es) (e.g., referred to herein as “one or more key bounding boxes”), in OCR data 206 (e.g., shown in FIG. 2A) that are associated with field key token(s) belonging to a field key associated with the extracted field value 210 (e.g., a field key used as input into the generative AI extraction model to initiate extraction of extracted field value 210, output by the model along with extracted field value 210). The field key may include one or more field key tokens. The one or more key bounding boxes may include a key bounding box surrounding each second OCR token. The second OCR tokens may be “associated with” the field key token(s) based on (1) the second OCR token(s) satisfying a typographical closeness threshold (e.g., either individually and/or one or more of the first OCR token(s) together) and (2) key bounding box(es) associated with one or more of the second OCR token(s) satisfying a spatial compactness threshold.

Bounding box generation 212 then proceeds, at block 228, with generating one or more key union bounding boxes in OCR data 206. For example, at block 228 (e.g., similar to block 222), a key union bounding box may create a “union” for one or more of the second OCR tokens (e.g., in some cases, a “union” may be created for only one second OCR token), and their corresponding key bounding box(es). More specifically, each key union bounding box may join OCR token(s) among the second OCR tokens that are geometrically compact (e.g., are associated with bounding box(es) that are geometrically compact). In some cases, one second OCR token may be determined to be “geometrically compact” with itself. In some cases, two or more second OCR tokens may be “geometrically compact” if they are sufficiently close to one another and satisfy a spatial compactness threshold.

In certain embodiments, each key union bounding box may include a same number of second OCR tokens as the number of field key tokens included in the field key. For example, each key union bounding box may include one second OCR token associated with each of the field key tokens in the field key. For example, if a field key “Social Security Tips” includes a first token “Social,” a second token “Security,” and a third token “Tips,” then each key union bounding box may include one second OCR token that is associated with token “Social,” another second OCR token that is associated with token “Security,” and another second OCR token that is associated with token “Tips.”

In certain embodiments, identifying second OCR token(s) that are typographically close to the field key token(s) and which have bounding box(es) that are geometrically compact, to generate a key union bounding box, involves performing an iterative process (e.g., similar to the iterative process used to generate a value union bounding box, as described above). This iterative process may be performed when the extracted field key includes more than one field key token. For example, the iterative process may begin by, for a first field key token of the field key, (1) identifying a first subset (e.g., one or more) of OCR tokens in the OCR data that are typographically close to the first field key token, (2) identifying a first subset of bounding boxes in the OCR data associated with the first subset of OCR tokens, and (3) setting a current set of bounding boxes (e.g., associated with the field key and not the extracted field value) to include the first subset of bounding boxes. Further, for each additional field key token included in the field key, the current set of bounding boxes may be reset (e.g., changed). For example, for a second field key token of the field key, the iterative process continues with (1) identifying a second subset of OCR tokens in the OCR data that are typographically close to the second field key token, (2) identifying a second subset of bounding boxes in the OCR data associated with the second subset of OCR tokens, (3) identifying at least one bounding box in the second subset of bounding boxes that satisfies a spatial compactness threshold when combined with at least one bounding box in the current set of bounding boxes, and (4) resetting the current set of bounding boxes to include the at least one bounding box in the second subset of bounding boxes and the at least one bounding box in the current set of bounding boxes. Similar steps may be performed for each remaining field key token of the field key. The final current set of bounding boxes (e.g., associated with the field key and not the extracted field value) may include key bounding boxes for which a key union bounding box is generated to surround.

At block 230, a matching pair of union bounding boxes is determined. For example, a matching pair of union bounding boxes may include (1) one key union bounding box among the one or more key union bounding boxes generated at block 228 and (2) one value union bounding box among the multiple value union bounding boxes generated at block 222. In other words, at block 230, OCR token(s), surrounded by a key union bounding box and associated with the field key token(s), are matched to OCR token(s), surrounded by a value union bounding box and associated with the field value token(s). The matching pair of union bounding boxes may be identified based on the one or more criteria.

For example, in certain embodiments, the matching pair of union bounding boxes may be identified using a minimum-distance bipartite matching algorithm. This algorithm may be used to (1) identify different candidate matching pairs of union bounding boxes among the bounding box(es) corresponding to OCR token(s) associated with the key union bounding box(es) and the value union bounding boxes, (2) determine a distance between union bounding boxes belonging to each candidate matching pair, and (3) summing the distances calculated for the candidate matching pairs. These steps may be repeated to identify candidate matching pairs that result in the smallest total distance calculated (e.g., indicating the shortest total distances between the candidate matching pairs).

As an illustrative example, all possible matches of key and value union bounding boxes for key-value pairs with the extracted field value (e.g., such as $0.00) may be considered. A set of matches where the total distances are minimized may indicate a “correct” set of matches. The matching pair of bounding boxes may then be identified based on this “correct” set of matches.

In certain embodiments, the matching pair of union bounding boxes may be identified using a beta-skeleton graph. A beta-skeleton graph is an undirected graph defined from a set of points. In certain embodiments, a beta-skeleton graph may be constructed by representing (1) each of the key union bounding box(es) as a point in the graph and (2) each of the value union bounding boxes as another point in the graph. Further, edges may be formed between (1) a point associated with one of the key union bounding boxes and (2) a point associated with one of the value union bounding boxes. Multiple beta-skeleton graphs may be constructed using these steps to identify a beta-skeleton graph that minimizes the number of edges that cross each other (e.g., minimize number of edge crossings).

In certain embodiments, the matching pair of union bounding boxes may be identified using a minimum-area bipartite matching algorithm. This algorithm may be used to (1) identify different candidate matching pairs of union bounding boxes among the key union bounding box(es) and the value union bounding boxes, (2) determine a smallest area surrounding the union bounding boxes belonging to each candidate matching pair, and (3) summing the areas determined for the candidate matching pairs. These steps may be repeated to identify candidate matching pairs that result in the smallest total area (e.g., indicating more compact candidate matching pairs).

A matching pair of union bounding boxes may include (1) one key union bounding box corresponding to OCR token(s) associated with field key token(s) of the field key and (2) one value union bounding box corresponding to OCR token(s) associated with field value token(s) of the extracted field value 210. This key union bounding box may represent an estimated location of the field key in OCR data 206. Similarly, this value union bounding box may represent an estimated location of the extracted field value 210 in OCR data 206. In certain embodiments, an output bounding box may be generated for display based on the coordinates associated with the value union bounding box of the matching pair of bounding boxes. Additionally, or alternatively, an output bounding box may be generated for display based on the coordinates associated with key union bounding box of the matching pair of bounding boxes (although not shown in workflow 200 of FIGS. 2A-2B).

An example scenario where multiple value union bounding boxes are generated at block 222, thereby leading to the performance of steps at block 224, 226, 228, and 230 are illustrated in FIGS. 4A-4C.

In FIG. 4A, an extracted field value 410 of “$0.00” is extracted from a document 402 (e.g., an IRS W-2 Form). For example, a generative AI extraction model may be used to extract extracted field value 410 of “$0.00” for a field key “Social security tips,” shown at 7 in document 402. The generative AI extraction model may use OCR data 406, generated for document 402, to perform the extraction of extracted field value 410. Extracted field Value 410 of “$0.00” may include a first field value token 420 (simply “token 420”) of “$” and a second field value token 422 (simply “token 422”) of “0.00.”

As shown in OCR data 406, ten OCR tokens 450 (e.g., each with a corresponding dotted bounding box, as shown in FIG. 4A) may be identified as being associated with token 420, “$.” For example, a typographical closeness between token 420, “$,” and each OCR token 450 may satisfy (e.g., be greater than) a typographical closeness threshold, indicating that each OCR token 450, in OCR data 406, has sufficient similarity to token 420, “$.” Similarly, three OCR tokens 452 (e.g., each with a corresponding dotted and line bounding box, as shown in FIG. 4A) may be identified as being associated with token 422, “0.00.” For example, a typographical closeness between token 422, “4.22,” and each OCR token 452 may satisfy (e.g., be greater than) the typographical closeness threshold, indicating that each OCR token 452, in OCR data 406, has sufficient similarity to token 422, “0.00.”

In FIG. 4B, multiple value union bounding boxes are generated in OCR data 406. The value union bounding boxes may each be generated to surround (1) one of the OCR tokens 450 associated with token 420, “$” and (2) one of the OCR tokens 450 associated with token 422, “0.00” (e.g., which together satisfy a spatial compactness threshold). Because there are more than one OCR tokens 450 associated with token 420, “$,” and/or more than one OCR token 450 associated with token 422, “0.00,” then more than one value union bounding boxes may be created in OCR data 406. Each value union bounding box may be created based on one of the OCR tokens 450 and one of the OCR tokens 452, shown in FIG. 4A, satisfying a spatial compactness threshold, indicating that the one OCR token 450 and the one OCR token 452 are sufficiently close together in document 402. In this example, three value union bounding boxes may be generated.

Because more than one value union bounding box is generated, it may be unclear which value union bounding box represents a location where extracted field value 410 was extracted. As such, one or more key union bounding boxes may be additionally generated in OCR data 406. For example, as shown in FIG. 4C, field key 412 of “Social security tips” may include a first field key token 430 (simply “token 430”) of “Social,” a second field key token 432 (simply “token 432”) of “Security,” and a third field key token 434 (simply “token 434”) of “Tips.”

As shown in OCR data 406, one OCR token 460 (e.g., with a corresponding bounding box, as shown in FIG. 4A) may be identified as being associated with token 430, “Social.” For example, a typographical closeness between token 430, “Social,” and the OCR token 460 may satisfy (e.g., be greater than) a typographical closeness threshold, indicating that the OCR token 460, in OCR date 406, has sufficient similarity to token 430, “Social.” Similarly, one OCR token 462 (e.g., with a corresponding bounding box, as shown in FIG. 4C) may be identified as being associated with token 432, “Security,” and one OCR token 464 (e.g., with a corresponding bounding box, as shown in FIG. 4C) may be identified as being associated with token 434, “Tips.”

In FIG. 4C, a key union bounding box is generated in OCR data 406. The key union bounding box may be generated to surround OCR token 460 associated with token 430, OCR token 462 associated with token 432, and OCR token 464 associated with token 434. The key union bounding box may be created based on OCR tokens 460, 462, and 464, shown in FIG. 4C, satisfying a spatial compactness threshold, indicating that OCR tokens 460, 462, and 464 are sufficiently close together in document 402.

A matching pair of bounding boxes 440 may include (1) the key union bounding box and (2) one of the three value union bounding boxes. To determine which of the three value union bounding boxes should be included in the matching pair of bounding boxes 440, in one example, a minimum-distance bipartite algorithm may be used. The algorithm may be used to determine a shortest distance between the edges of the key union bounding box and the edges of the first value union bounding box 470. The algorithm may be used to determine a shortest distance between the edges of the key union bounding box and the edges of the second value union bounding box 472. Additionally, the algorithm may be used to determine a shortest distance between the edges of the key union bounding box and the coordinates of the third value union bounding box 474. In this example, the shortest distance (of all three distances determined) may exist between the key union bounding box and the second value union bounding box 472. As such, the matching pair of bounding boxes 440 may include (1) the key union bounding box and (2) the second value union bounding box 472, as shown in FIG. 4C.

Coordinates of the second value union bounding box 472, with respect to known dimensions of the document 402 used to generate OCR data 406, may be used to determine coordinates for an output bounding box 442 in document 402. For example, the coordinates of the second value union bounding box 472 may be relative to dimensions of the document 402, such that if the document 402 is re-sized prior to generation of the output bounding box 442, then the output bounding box 442 can be re-sized accordingly. As shown, output bounding box 442 may be generated as an outline (e.g., generally rectangular outline) surrounding tokens in the document corresponding to OCR tokens surrounded by the second value union bounding box 472 in OCR data 406.

### Example Method for Bounding Box Generation

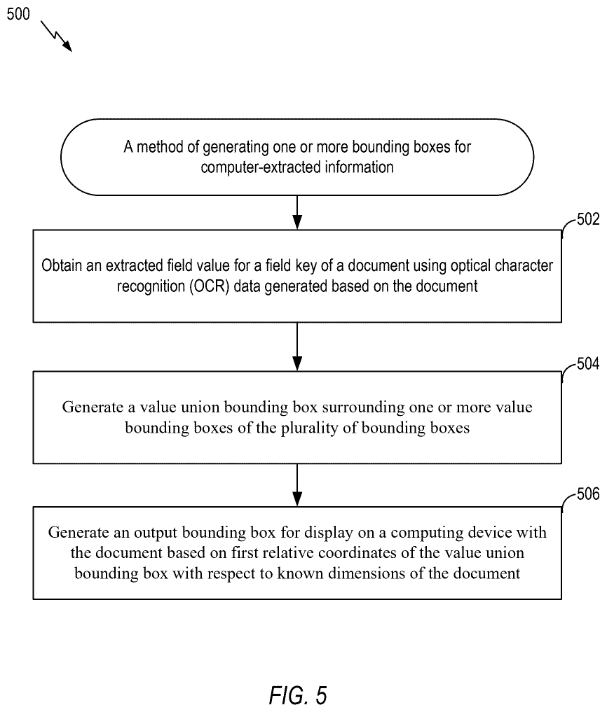

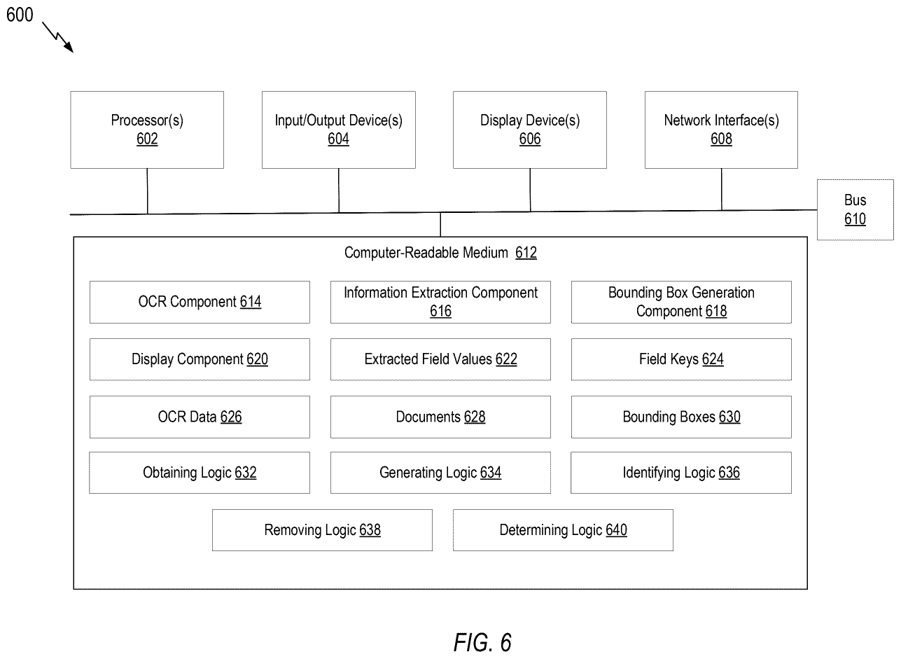

FIG. 5 depicts an example method 500 for generating bounding box(es) for computer-extracted information. Method 500 may be performed by one or more processor(s) of a computing device, such as processor(s) 602 of processing system 600 described below with respect to FIG. 6.

Method 500 begins, at block 502, with obtaining an extracted field value for a field key of a document using OCR data generated based on the document. Obtaining an extracted field value for a field key of a document using OCR data may be performed in a manner similar to that described above, such as during OCR 204 and information extraction 208 in FIG. 2A. The OCR data may include a plurality of OCR tokens associated with the document. The OCR data may include a plurality of bounding boxes, each associated with one OCR token of the plurality of OCR tokens. The extracted field value may include one or more field value tokens.

Method 500 proceeds, at block 504, with generating a value union bounding box surrounding one or more value bounding boxes of the plurality of bounding boxes. Generating a value union bounding box may be performed in a manner similar to that described above, such as during bounding box generation 212 in FIG. 2A, and more specifically at block 222 in FIG. 2C, as well as with respect to the examples in FIG. 3B and FIG. 4B. The one or more value bounding boxes may satisfy a first threshold. The one or more value bounding boxes may be associated with one or more first OCR tokens of the plurality of OCR tokens that satisfy a second threshold when compared to the one or more field value tokens.

As described herein, generating a value union bounding box provides the technical benefit of being able to generate an output bounding box for an extracted field value with (1) multiple tokens and/or (2) token(s) that do not match exactly token(s) in the OCR data (e.g., token(s) that are generated by a generative AI extraction model). For example, a value union bounding box may surround token(s) that are (1) typographically close to an extracted field value and (2) associated with bounding boxes that are geometrically compact. Utilizing a typographically close threshold to identify OCR token(s) helps in cases where the extracted field value token(s) are not included in the OCR data because an exact match is not needed to determine that at least two tokens (e.g., an OCR token and an extracted field value token) are similar. Further, utilizing a geometrically compact threshold to identify OCR token(s) helps in cases where the extracted field value includes multiple tokens because a correct extracted field value would likely be found within a compact area/location in the document. As such, the typographically close and geometrically compact thresholds help to narrow down the pool of OCR tokens, and more specifically, narrow down locations associated with the pool of OCR tokens indicating where the extracted field value (e.g., including one or more field value tokens) may have been extracted from.

Method 500 proceeds, at block 506, with generating an output bounding box for display on a computing device with the document based on first relative coordinates of the value union bounding box with respect to known dimensions of the document. Generating an output bounding box may be performed in a manner similar to that described above, such as during bounding box generation 212 and display 216 in FIG. 2A, as well as with respect to the examples in FIG. 3B and FIG. 4C.

In certain embodiments, the extracted field value includes a plurality of field value tokens.

In certain embodiments, the value union bounding box surrounds a quantity of the one or more value bounding boxes less than or equal to a quantity of the one or more field value tokens.

In certain embodiments, the extracted field value includes a plurality of field value tokens. In certain embodiments, the value union bounding box surrounds the quantity of the one or more value bounding boxes equal to the quantity of the plurality of field value tokens. Further, in certain embodiments, generating the value union bounding box includes: for a first field value token of the plurality of field value tokens: identifying a first subset of OCR tokens in the OCR data that satisfy the second threshold when individually compared to the first field value token; identifying a first subset of bounding boxes associated with the first subset of OCR tokens; and setting a current set of bounding boxes to include the first subset of bounding boxes. Further, for each respective field value token remaining in the plurality of field value tokens, generating the value union bounding box includes: identifying a second subset of OCR tokens in the OCR data that satisfy the second threshold when individually compared to the respective field value token; identifying a second subset of bounding boxes associated with the second subset of OCR tokens; identifying at least one bounding box in the second subset of bounding boxes that satisfies the first threshold when combined with at least one bounding box in the current set of bounding boxes; and resetting the current set of bounding boxes to include the at least one bounding box in the second subset of bounding boxes and the at least one bounding box in the current set of bounding boxes. In certain embodiments, the value union bounding box surrounds the current set of bounding boxes.

In certain embodiments, the second threshold is a typographical closeness threshold. In certain embodiments, the plurality of OCR tokens in the OCR data are represented in a trie data structure. In certain embodiments, the first subset of OCR tokens and each second subset of OCR tokens are identified using the trie data structure.

In certain embodiments, the OCR data includes geometric information associated with the document. In certain embodiments, the first threshold is a spatial compactness threshold. In certain embodiments, identifying the at least one bounding box in the second subset of bounding boxes is based on the geometric information.

In certain embodiments, the plurality of OCR tokens in the OCR data are represented in a trie data structure. In certain embodiments, method 500 further includes, after generating the value union bounding box, removing the one or more first OCR tokens from the trie data structure.

In certain embodiments, the field key includes one or more field key tokens. In certain embodiments, generating the value union bounding box comprises generating a plurality of value union bounding boxes in the OCR data. In certain embodiments, method 500 further includes: generating at least one key union bounding box surrounding one or more key bounding boxes of the plurality of bounding boxes. In certain embodiments, the one or more key bounding boxes satisfy the first threshold. Further, in certain embodiments, the one or more key bounding boxes are associated with one or more second OCR tokens of the plurality of OCR tokens that satisfy the second threshold when compared to the one or more field key tokens.

In certain embodiments, method 500 further includes, based on one or more criteria, determining a matching pair of union bounding boxes comprising: one key union bounding box of the at least one key union bounding box, and one value union bounding box of the plurality of value union bounding boxes, wherein generating the output bounding box for display on the computing device with the document is based on the first relative coordinates of the one value union bounding box, belonging to the matching pair of union bounding boxes, with respect to the known dimensions of the document.

In certain embodiments, the one or more criteria include at least one of: minimizing a sum of distances between candidate pairs of union bounding boxes associated with the at least one key union bounding box and the plurality of value union bounding boxes; minimizing a number of edge crossings between the candidate pairs of union bounding boxes associated with the at least one key union bounding box and the plurality of value union bounding boxes; or minimizing a sum of areas encompassed by the candidate pairs of union bounding boxes associated with the at least one key union bounding box and the plurality of value union bounding boxes.

In certain embodiments, generating the output bounding box for display on the computing device with the document is further based on second relative coordinates of the one key union bounding box, belonging to the matching pair of union bounding boxes, with respect to the known dimensions of the document.

In certain embodiments, the field key includes a plurality of field key tokens.

In certain embodiments, the key union bounding box surrounds a quantity of the one or more key bounding boxes less than or equal to a quantity of the one or more field key tokens.

In certain embodiments, the field key includes a plurality of field key tokens. In certain embodiments, the key union bounding box surrounds the one or more key bounding boxes equal to the quantity of the one or more field key tokens. In certain embodiments, generating the key union bounding box includes: for a first field key token of the plurality of field key tokens: identifying a third subset of OCR tokens in the OCR data that satisfy the second threshold when individually compared to the first field key token; identifying a third subset of bounding boxes associated with the third subset of OCR tokens; and setting a current set of bounding boxes to include the third subset of bounding boxes. In certain embodiments, for each respective field key token remaining in the plurality of field key tokens, generating the key union bounding box includes: identifying a fourth subset of OCR tokens in the OCR data that satisfy the second threshold when individually compared to the respective field key token; identifying a fourth subset of bounding boxes associated with the fourth subset of OCR tokens; identifying one or more bounding boxes in the fourth subset of bounding boxes that satisfy the first threshold when combined with one or more bounding boxes in the current set of bounding boxes; and resetting the current set of bounding boxes to include the one or more bounding boxes in the fourth subset of bounding boxes and the one or more bounding boxes in the current set of bounding boxes. In certain embodiments, the key union bounding box surrounds the current set of bounding boxes.

In certain embodiments, the second threshold comprises a typographical closeness threshold. In certain embodiments, the plurality of OCR tokens in the OCR data are represented in a trie data structure. In certain embodiments, the third subset of OCR tokens and each fourth subset of OCR tokens are identified using the trie data structure.

In certain embodiments, the OCR data includes geometric information associated with the document. In certain embodiments, the first threshold includes a spatial compactness threshold. In certain embodiments, identifying the one or more bounding boxes in the fourth subset is based on the geometric information.

In certain embodiments, the plurality of OCR tokens in the OCR data are represented in a trie data structure. In certain embodiments, method 500 further includes, after generating the at least one key union bounding box, removing the one or more second OCR tokens from the trie data structure.

In certain embodiments, the field key includes at least one of: a taxpayer legal name field key; a taxpayer legal address field key; a taxpayer identification field key; a wages, tips, and other compensation field key associated with an Internal Revenue Service (IRS) Form W-2; a federal income tax withheld field key associated with the IRS Form W-2; a total ordinary dividends field key associated with an IRS Form 1099-DIV; a qualified dividends field key associated with the IRS Form 1099-DIV; a total capital gain distribution field key associated with the IRS Form 1099-DIV; a payments received for qualified tuition and related expenses field key associated with an IRS 1098-T field; or a scholarships or grants field key associated with the IRS 1098-T field.

Note that FIG. 5 is just one example of a method, and other methods including fewer, additional, or alternative steps are possible consistent with this disclosure.

### Example Processing System for Bounding Box Annotation

FIG. 6 depicts an example processing system 600 configured to perform various aspects described herein, including, for example, method 500 as described above with respect to FIG. 5.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, input/output device(s) 604, display device(s) 606, network interface(s) 608, and/or computer-readable medium 612. In certain embodiments, processor(s) 602 are representative of one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes an OCR component 614, an information extraction component 616, a bounding box generation component 618, a display component 620, extracted field values 622, field keys 624, OCR data 626, documents 628, bounding boxes 630, obtaining logic 632, generating logic 634, identifying logic 636, removing logic 638, and determining logic 640.

In certain embodiments, obtaining logic 632 includes logic for obtaining an extracted field value for a field key of a document using OCR data generated based on the document. The OCR data may include a plurality of OCR tokens associated with the document.

In certain embodiments, generating logic 634 includes logic for generating a value union bounding box surrounding at least two value bounding boxes of the plurality of bounding boxes associated with at least two OCR tokens in the OCR data. In certain embodiments, generating logic 634 includes logic for generating an output bounding box for display on a computing device with the document based on first relative coordinates of the value union bounding with respect to known dimensions of the document associated with the OCR data. In certain embodiments, generating logic 634 includes logic for generating a plurality of value union bounding boxes in the OCR data. In certain embodiments, generating logic 634 includes logic for generating the output bounding box for display on the computing device with the document based on second relative coordinates of the one value union bounding box, belonging to the matching pair of bounding boxes, with respect to the known dimensions of the document associated with the OCR data. In certain embodiments, generating logic 634 includes logic for generating at least one key union bounding box surrounding at least two key bounding boxes of the plurality of bounding boxes associated with at least another two OCR tokens in the OCR data. In certain embodiments, generating logic 634 includes logic for generating the output bounding box in the document for display on the computing device based on second relative coordinates of the one value union bounding box, belonging to the matching pair of bounding boxes, with respect to the known dimensions of the document associated with the OCR data.

In certain embodiments, identifying logic 636 includes logic for identifying a second subset of OCR tokens in the OCR data that satisfy the first threshold when individually compared to one of the plurality of field value tokens; identifying a second subset of bounding boxes in the plurality of bounding boxes associated with the second subset of OCR tokens; and identifying the at least two key bounding boxes in the second subset of bounding boxes that satisfy the second threshold. In certain embodiments, identifying logic 636 includes logic for identifying a first subset of OCR tokens in the OCR data that satisfy the first threshold when individually compared to one of the plurality of field value tokens; identifying a first subset of bounding boxes in the plurality of bounding boxes associated with the first subset of OCR tokens; and identifying the at least two value bounding boxes in the first subset of bounding boxes that satisfy the second threshold. In certain embodiments, identifying logic 636 includes logic for, for each respective field value token of the plurality of field value tokens, identifying one or more of the OCR tokens in the OCR data that satisfy the first threshold when compared to the respective field value token using the trie data structure. In certain embodiments, identifying logic 636 includes logic for identifying the at least two value bounding boxes in the first subset of bounding boxes that satisfy the second threshold based on the geometric information.

In certain embodiments, identifying logic 636 includes logic for identifying one or more key bounding boxes of the plurality of bounding boxes in the OCR data associated with a variation of the single field key token among one or more variations of the single field key token; and based on one or more criteria.

In certain embodiments, removing logic 638 includes logic for removing the at least OCR tokens from the trie data structure.

In certain embodiments, determining logic 640 includes logic for determining a matching pair of bounding boxes based on one or more criteria. In certain embodiments, determining logic 640 includes logic for determining the matching pair of bounding boxes based on at least one of: a sum of distances between candidate pairs of bounding boxes associated with the one or more key bounding boxes and the plurality of value union bounding boxes, including the matching pair of bounding boxes, is minimized; a number of edges between the candidate pairs of bounding boxes associated with the one or more key bounding boxes and the plurality of value union bounding boxes, including the matching pair of bounding boxes, is minimized; or a sum of areas encompassed by the candidate pairs of bounding boxes associated with the one or more key bounding boxes and the plurality of value union bounding boxes, including the matching pair of bounding boxes, is minimized. In certain embodiments, determining logic 640 includes logic for determining the matching pair of bounding boxes based on at least one of: a sum of distances between candidate pairs of bounding boxes associated with the at least one key union bounding box and the plurality of value union bounding boxes, including the matching pair of bounding boxes, is minimized; a number of edges between the candidate pairs of bounding boxes associated with the at least one key union bounding box and the plurality of value union bounding boxes, including the matching pair of bounding boxes, is minimized; or a sum of areas encompassed by the candidate pairs of bounding boxes associated with the at least one key union bounding box and the plurality of value union bounding boxes, including the matching pair of bounding boxes, is minimized.

Note that FIG. 6 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method of generating one or more bounding boxes for computer-extracted information, comprising: obtaining an extracted field value for a field key of a document using optical character recognition (OCR) data generated based on the document, wherein: the OCR data comprises a plurality of OCR tokens, the OCR data comprises a plurality of bounding boxes, each associated with one OCR token of the plurality of OCR tokens, and the extracted field value comprises one or more field value tokens; generating a value union bounding box surrounding one or more value bounding boxes of the plurality of bounding boxes, wherein: the one or more value bounding boxes satisfy a first threshold; and the one or more value bounding boxes are associated with one or more first OCR tokens of the plurality of OCR tokens that satisfy a second threshold when compared to the one or more field value tokens; and generating an output bounding box for display on a computing device with the document based on first relative coordinates of the value union bounding box with respect to known dimensions of the document.

Clause 2: The method of Clause 1, wherein the extracted field value comprises a plurality of field value tokens.

Clause 3: The method of any one of Clauses 1-2, wherein the value union bounding box surrounds a quantity of the one or more value bounding boxes less than or equal to a quantity of the one or more field value tokens.

Clause 4: The method of Clause 3, wherein: the extracted field value comprises a plurality of field value tokens, the value union bounding box surrounds the quantity of the one or more value bounding boxes equal to the quantity of the plurality of field value tokens, and generating the value union bounding box comprises: for a first field value token of the plurality of field value tokens: identifying a first subset of OCR tokens in the OCR data that satisfy the second threshold when individually compared to the first field value token; identifying a first subset of bounding boxes associated with the first subset of OCR tokens; and setting a current set of bounding boxes to include the first subset of bounding boxes; and for each respective field value token remaining in the plurality of field value tokens: identifying a second subset of OCR tokens in the OCR data that satisfy the second threshold when individually compared to the respective field value token; identifying a second subset of bounding boxes associated with the second subset of OCR tokens; identifying at least one bounding box in the second subset of bounding boxes that satisfies the first threshold when combined with at least one bounding box in the current set of bounding boxes; and resetting the current set of bounding boxes to include the at least one bounding box in the second subset of bounding boxes and the at least one bounding box in the current set of bounding boxes, wherein the value union bounding box surrounds the current set of bounding boxes.

Clause 5: The method of Clause 4, wherein: the second threshold comprises a typographical closeness threshold, the plurality of OCR tokens in the OCR data are represented in a trie data structure, and the first subset of OCR tokens and each second subset of OCR tokens are identified using the trie data structure.

Clause 6: The method of any one of Clauses 4-5, wherein: the OCR data comprises geometric information associated with the document, the first threshold comprises a spatial compactness threshold, and identifying the at least one bounding box in the second subset of bounding boxes is based on the geometric information.

Clause 7: The method of any one of Clauses 1-6, wherein: the plurality of OCR tokens in the OCR data are represented in a trie data structure; and the method further comprises, after generating the value union bounding box, removing the one or more first OCR tokens from the trie data structure.

Clause 8: The method of any one of Clauses 1-7, wherein: the field key comprises one or more field key tokens, generating the value union bounding box comprises generating a plurality of value union bounding boxes in the OCR data, and the method further comprises: generating at least one key union bounding box surrounding one or more key bounding boxes of the plurality of bounding boxes, wherein: the one or more key bounding boxes satisfy the first threshold; and the one or more key bounding boxes are associated with one or more second OCR tokens of the plurality of OCR tokens that satisfy the second threshold when compared to the one or more field key tokens.

Clause 9: The method of Clause 8, further comprising: based on one or more criteria, determining a matching pair of union bounding boxes comprising: one key union bounding box of the at least one key union bounding box, and one value union bounding box of the plurality of value union bounding boxes, wherein generating the output bounding box for display on the computing device with the document is based on the first relative coordinates of the one value union bounding box, belonging to the matching pair of union bounding boxes, with respect to the known dimensions of the document.

Clause 10: The method of Clause 9, wherein the one or more criteria comprises at least one of: minimizing a sum of distances between candidate pairs of union bounding boxes associated with the at least one key union bounding box and the plurality of value union bounding boxes; minimizing a number of edge crossings between the candidate pairs of union bounding boxes associated with the at least one key union bounding box and the plurality of value union bounding boxes; or minimizing a sum of areas encompassed by the candidate pairs of union bounding boxes associated with the at least one key union bounding box and the plurality of value union bounding boxes.

Clause 11: The method of any one of Clauses 9-10, wherein generating the output bounding box for display on the computing device with the document is further based on second relative coordinates of the one key union bounding box, belonging to the matching pair of union bounding boxes, with respect to the known dimensions of the document.

Clause 12: The method of any one of Clauses 8-11, wherein the field key comprises a plurality of field key tokens.

Clause 13: The method of any one of Clauses 8-12, wherein the key union bounding box surrounds a quantity of the one or more key bounding boxes less than or equal to a quantity of the one or more field key tokens.

Clause 14: The method of Clause 13, wherein: the field key comprises a plurality of field key tokens, the key union bounding box surrounds the one or more key bounding boxes equal to the quantity of the one or more field key tokens, and generating the key union bounding box comprises: for a first field key token of the plurality of field key tokens: identifying a third subset of OCR tokens in the OCR data that satisfy the second threshold when individually compared to the first field key token; identifying a third subset of bounding boxes associated with the third subset of OCR tokens; and setting a current set of bounding boxes to include the third subset of bounding boxes; and for each respective field key token remaining in the plurality of field key tokens: identifying a fourth subset of OCR tokens in the OCR data that satisfy the second threshold when individually compared to the respective field key token; identifying a fourth subset of bounding boxes associated with the fourth subset of OCR tokens; identifying one or more bounding boxes in the fourth subset of bounding boxes that satisfy the first threshold when combined with one or more bounding boxes in the current set of bounding boxes; and resetting the current set of bounding boxes to include the one or more bounding boxes in the fourth subset of bounding boxes and the one or more bounding boxes in the current set of bounding boxes, wherein the key union bounding box surrounds the current set of bounding boxes.

Clause 15: The method of Clause 14, wherein: the second threshold comprises a typographical closeness threshold, the plurality of OCR tokens in the OCR data are represented in a trie data structure, and the third subset of OCR tokens and each fourth subset of OCR tokens are identified using the trie data structure.

Clause 16: The method of any one of Clauses 14-15, wherein: the OCR data comprises geometric information associated with the document, the first threshold comprises a spatial compactness threshold, and identifying the one or more bounding boxes in the fourth subset is based on the geometric information.

Clause 17: The method of any one of Clauses 8-16, wherein: the plurality of OCR tokens in the OCR data are represented in a trie data structure; and the method further comprises, after generating the at least one key union bounding box, removing the one or more second OCR tokens from the trie data structure.

Clause 18: The method of any one of Clauses 1-17, wherein the field key comprises at least one of: a taxpayer legal name field key; a taxpayer legal address field key; a taxpayer identification field key; a wages, tips, and other compensation field key associated with an Internal Revenue Service (IRS) Form W-2; a federal income tax withheld field key associated with the IRS Form W-2; a total ordinary dividends field key associated with an IRS Form 1099-DIV; a qualified dividends field key associated with the IRS Form 1099-DIV; a total capital gain distribution field key associated with the IRS Form 1099-DIV; a payments received for qualified tuition and related expenses field key associated with an IRS 1098-T field; or a scholarships or grants field key associated with the IRS 1098-T field.

Clause 19: A processing system, comprising: one or more memories comprising computer-executable instructions; and one or more processors configured to execute the computer-executable instructions and cause the processing system to perform a method in accordance with any one of Clauses 1-18.

Clause 20: A processing system, comprising means for performing a method in accordance with any one of Clauses 1-18.

Clause 21: A non-transitory computer-readable medium storing program code for causing a processing system to perform the steps of any one of Clauses 1-18.

Clause 22: A computer program product embodied on a computer-readable storage medium comprising code for performing a method in accordance with any one of Clauses 1-18.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating one or more bounding boxes for computer-extracted information, comprising:
obtaining an extracted field value for a field key of a document using optical character recognition (OCR) data generated based on the document, wherein:
the OCR data comprises a plurality of OCR tokens,
the OCR data comprises a plurality of bounding boxes, each associated with one OCR token of the plurality of OCR tokens, and
the extracted field value comprises one or more field value tokens;
generating a value union bounding box surrounding one or more value bounding boxes of the plurality of bounding boxes, wherein:
the one or more value bounding boxes satisfy a first threshold; and
the one or more value bounding boxes are associated with one or more first OCR tokens of the plurality of OCR tokens that satisfy a second threshold when compared to the one or more field value tokens; and
generating an output bounding box for display on a computing device with the document based on first relative coordinates of the value union bounding box with respect to known dimensions of the document.

2. The method of claim 1, wherein the extracted field value comprises a plurality of field value tokens.

3. The method of claim 1, wherein the value union bounding box surrounds a quantity of the one or more value bounding boxes less than or equal to a quantity of the one or more field value tokens.

4. The method of claim 3, wherein:
the extracted field value comprises a plurality of field value tokens,
the value union bounding box surrounds the quantity of the one or more value bounding boxes equal to the quantity of the plurality of field value tokens, and
generating the value union bounding box comprises:
for a first field value token of the plurality of field value tokens:
identifying a first subset of OCR tokens in the OCR data that satisfy the second threshold when individually compared to the first field value token;
identifying a first subset of bounding boxes associated with the first subset of OCR tokens; and
setting a current set of bounding boxes to include the first subset of bounding boxes; and
for each respective field value token remaining in the plurality of field value tokens:
identifying a second subset of OCR tokens in the OCR data that satisfy the second threshold when individually compared to the respective field value token;
identifying a second subset of bounding boxes associated with the second subset of OCR tokens;
identifying at least one bounding box in the second subset of bounding boxes that satisfies the first threshold when combined with at least one bounding box in the current set of bounding boxes; and
resetting the current set of bounding boxes to include the at least one bounding box in the second subset of bounding boxes and the at least one bounding box in the current set of bounding boxes,
wherein the value union bounding box surrounds the current set of bounding boxes.

5. The method of claim 4, wherein:
the second threshold comprises a typographical closeness threshold,
the plurality of OCR tokens in the OCR data are represented in a trie data structure, and the first subset of OCR tokens and each second subset of OCR tokens are identified using the trie data structure.

6. The method of claim 4, wherein:
the OCR data comprises geometric information associated with the document,
the first threshold comprises a spatial compactness threshold, and
identifying the at least one bounding box in the second subset of bounding boxes is based on the geometric information.

7. The method of claim 1, wherein:
the plurality of OCR tokens in the OCR data are represented in a trie data structure; and
the method further comprises, after generating the value union bounding box, removing the one or more first OCR tokens from the trie data structure.

8. The method of claim 1, wherein:
the field key comprises one or more field key tokens,
generating the value union bounding box comprises generating a plurality of value union bounding boxes in the OCR data, and
the method further comprises:
generating at least one key union bounding box surrounding one or more key bounding boxes of the plurality of bounding boxes, wherein:
the one or more key bounding boxes satisfy the first threshold; and
the one or more key bounding boxes are associated with one or more second OCR tokens of the plurality of OCR tokens that satisfy the second threshold when compared to the one or more field key tokens.

9. The method of claim 8, further comprising:
based on one or more criteria, determining a matching pair of union bounding boxes comprising:
one key union bounding box of the at least one key union bounding box, and
one value union bounding box of the plurality of value union bounding boxes,
wherein generating the output bounding box for display on the computing device with the document is based on the first relative coordinates of the one value union bounding box, belonging to the matching pair of union bounding boxes, with respect to the known dimensions of the document.

10. The method of claim 9, wherein the one or more criteria comprises at least one of:
minimizing a sum of distances between candidate pairs of union bounding boxes associated with the at least one key union bounding box and the plurality of value union bounding boxes;
minimizing a number of edge crossings between the candidate pairs of union bounding boxes associated with the at least one key union bounding box and the plurality of value union bounding boxes; or
minimizing a sum of areas encompassed by the candidate pairs of union bounding boxes associated with the at least one key union bounding box and the plurality of value union bounding boxes.

11. The method of claim 9, wherein generating the output bounding box for display on the computing device with the document is further based on second relative coordinates of the one key union bounding box, belonging to the matching pair of union bounding boxes, with respect to the known dimensions of the document.

12. The method of claim 8, wherein the field key comprises a plurality of field key tokens.

13. The method of claim 8, wherein the key union bounding box surrounds a quantity of the one or more key bounding boxes less than or equal to a quantity of the one or more field key tokens.

14. The method of claim 13, wherein:
the field key comprises a plurality of field key tokens,
the key union bounding box surrounds the one or more key bounding boxes equal to the quantity of the one or more field key tokens, and
generating the key union bounding box comprises:
for a first field key token of the plurality of field key tokens:
identifying a third subset of OCR tokens in the OCR data that satisfy the second threshold when individually compared to the first field key token;
identifying a third subset of bounding boxes associated with the third subset of OCR tokens; and
setting a current set of bounding boxes to include the third subset of bounding boxes; and
for each respective field key token remaining in the plurality of field key tokens:
identifying a fourth subset of OCR tokens in the OCR data that satisfy the second threshold when individually compared to the respective field key token;
identifying a fourth subset of bounding boxes associated with the fourth subset of OCR tokens;
identifying one or more bounding boxes in the fourth subset of bounding boxes that satisfy the first threshold when combined with one or more bounding boxes in the current set of bounding boxes; and
resetting the current set of bounding boxes to include the one or more bounding boxes in the fourth subset of bounding boxes and the one or more bounding boxes in the current set of bounding boxes,
wherein the key union bounding box surrounds the current set of bounding boxes.

15. The method of claim 14, wherein:
the second threshold comprises a typographical closeness threshold,
the plurality of OCR tokens in the OCR data are represented in a trie data structure, and
the third subset of OCR tokens and each fourth subset of OCR tokens are identified using the trie data structure.

16. The method of claim 14, wherein:
the OCR data comprises geometric information associated with the document,
the first threshold comprises a spatial compactness threshold, and
identifying the one or more bounding boxes in the fourth subset is based on the geometric information.

17. The method of claim 8, wherein:
the plurality of OCR tokens in the OCR data are represented in a trie data structure; and
the method further comprises, after generating the at least one key union bounding box, removing the one or more second OCR tokens from the trie data structure.

18. The method of claim 1, wherein the field key comprises at least one of:
a taxpayer legal name field key;
a taxpayer legal address field key;
a taxpayer identification field key;
a wages, tips, and other compensation field key associated with an Internal Revenue Service (IRS) Form W-2;
a federal income tax withheld field key associated with the IRS Form W-2;
a total ordinary dividends field key associated with an IRS Form 1099-DIV;
a qualified dividends field key associated with the IRS Form 1099-DIV;
a total capital gain distribution field key associated with the IRS Form 1099-DIV;
a payments received for qualified tuition and related expenses field key associated with an IRS 1098-T field; or
a scholarships or grants field key associated with the IRS 1098-T field.

19. A processing system, comprising:
one or more memories comprising computer-executable instructions; and
one or more processors configured to execute the computer-executable instructions and cause the processing system to:
obtain an extracted field value for a field key of a document using optical character recognition (OCR) data generated based on the document, wherein:
the OCR data comprises a plurality of OCR tokens,
the OCR data comprises a plurality of bounding boxes, each associated with one OCR token of the plurality of OCR tokens, and
the extracted field value comprises one or more field value tokens;
generate a value union bounding box surrounding one or more value bounding boxes of the plurality of bounding boxes, wherein:
the one or more value bounding boxes satisfy a first threshold; and
the one or more value bounding boxes are associated with one or more first OCR tokens of the plurality of OCR tokens that satisfy a second threshold when compared to the one or more field value tokens; and
generate an output bounding box for display on a computing device with the document based on first relative coordinates of the value union bounding box with respect to known dimensions of the document.

20. The processing system of claim 19, wherein:
the field key comprises one or more field key tokens,
to generate the value union bounding box, the one or more processors configured to execute the computer-executable instructions and cause the processing system to generate a plurality of value union bounding boxes in the OCR data, and
the one or more processors configured to execute the computer-executable instructions and further cause the processing system to:
generate at least one key union bounding box surrounding one or more key bounding boxes of the plurality of bounding boxes, wherein:
the one or more key bounding boxes satisfy the first threshold; and
the one or more key bounding boxes are associated with one or more second OCR tokens of the plurality of OCR tokens that satisfy the second threshold when compared to the one or more field key tokens.
